(19) United States
(12) Patent Application Publication
(10) Pub. No.: US 2004/0139211 A1
(43) Pub. Date: Jul. 15, 2004

(54) Systems and methods for prevention of peer-to-peer file sharing

(75) Inventors: Peter D. Baker, Aliso Viejo, CA (US); Karen Neal, Los Angeles, CA (US); Susan L. Baker, Aliso Viejo, CA (US)

Correspondence Address: ORRICK, HERRINGTON & SUTCLIFFE, LLP, 4 PARK PLAZA, SUITE 1600, IRVINE, CA, 92614-2558, US

(73) Assignee: NB Networks, Aliso Viejo, CA

(21) Appl. No.: 10/715,954

(22) Filed: Nov. 17, 2003

Related U.S. Application Data
(63) Continuation-in-part of application No. 10/272,471, filed on Oct. 15, 2002, now Pat. No. 6,651,102.
Application No. 10/272,471 is a continuation-in-part of application No. 09/898,852, filed on Jul. 3, 2001, now Pat. No. 6,493,761.
Application No. 09/898,852 is a continuation-in-part of application No. 09/113,704, filed on Jul. 10, 1998, now Pat. No. 6,266,700.
Application No. 09/113,704 is a continuation of application No. 09/080,325, filed on May 15, 1998, now Pat. No. 6,000,041.
Application No. 09/080,325 is a continuation of application No. 08/888,875, filed on Jul. 7, 1997, now Pat. No. 5,781,729.
Application No. 08/888,875 is a continuation of application No. 08/575,506, filed on Dec. 20, 1995, now Pat. No. 5,793,954.

(51) Int. Cl. G06F 15/16

(52) U.S. Cl. 709/230

(57) ABSTRACT

A secure digital content delivery system includes a content provider and a content user. The content provider delivers encrypted content to the content user in response to delivery requests. The content provider generates encryption algorithms on the fly and encrypts the content prior to delivery, using a different encryption algorithm and key for each content delivery. The content user subsequently requests access permission from the content provider, to access the encrypted content. The content provider grants access by generating an executable decryption module on the fly and providing the executable decryption module to the content user. The content user decrypts the content and accesses it on the fly, using the executable decryption module. The accessed content is then re-encrypted using a different encryption algorithm and key, to preserve the integrity of the secure content delivery system. The content delivery system uses a programmably configurable protocol parsing engine to encrypt and decrypt content.

### PRIORITY INFORMATION

This is a continuation-in-part of application U.S. Ser. No. 10/272,471, filed on Oct. 15, 2002, which issued as U.S. Pat. No. 6,651,102 on Nov. 18, 2003, which is a continuation-in-part of application U.S. Ser. No. 09/898,852, filed on Jul. 3, 2001, which issued as U.S. Pat. No. 6,493,761 on Dec. 10, 2002, which is a continuation-in-part of application U.S. Ser. No. 09/113,704, filed on Jul. 10, 1998, which issued as U.S. Pat. No. 6,266,700 on Jul. 24, 2001, which is a continuation of U.S. Ser. No. 09/080,325, filed on May 15, 1998, which issued as U.S. Pat. No. 6,000,041 on Dec. 7, 1999, which is a continuation of U.S. Ser. No. 08/888,875, filed on Jul. 7, 1997, which issued as U.S. Pat. No. 5,781,729 on Jul. 14, 1998, which is a continuation of U.S. Ser. No. 08/575,506, filed on Dec. 20, 1995, which issued as U.S. Pat. No. 5,793,954 on Aug. 11, 1998, the disclosures of which are expressly incorporated herein by reference.

### COPYRIGHT NOTICE

A portion of the disclosure of this patent document contains material that is subject to copyright protection. The copyright owner has no objection to the xerographic reproduction by anyone of the patent document or the patent disclosure in exactly the form it appears in the Patent and Trademark Office patent file or records, but otherwise reserves all copyright rights whatsoever.

### FIELD OF THE INVENTION

The field of the invention relates to distribution of content over a network or stored on electronic media, and more particularly to systems and methods of protecting content from unauthorized distribution.

### BACKGROUND OF THE INVENTION

With the burgeoning growth of the Internet, there is an ever-increasing amount of content being distributed over the Internet. As technology progresses, consumers are demanding that more content be made available in digital form, to take advantage of the improved sound and visual quality provided by digital recordings. Digital content such as music, movies, software, and the like are rapidly becoming the most popular types of files being transmitted across the Internet.

Unfortunately, much of this digital content transmission is being done without the authorization of the rightful owners of the content. Since modern computer technology allows digital content to be easily and cheaply copied, with no loss in the quality of the original recording, it has become very easy to create perfect copies of digital content. Now that any personal computer, for example, can make a perfect copy of digital content, it has become very easy for people to make unauthorized copies of digital content, potentially costing the legitimate owners of the digital content millions or even billions of dollars of lost revenue.

In response to all of this unauthorized copying, the rightful owners and distributors of digital content have resorted to a variety of technological methods to prevent copying. For example, software manufacturers have tried embedding secret codes into the distribution media (e.g. CD-ROMs or floppy disks), in sectors of the distribution media that are not easily accessed by users. The software is configured to check for the existence of the secret code, and if the code is not present, the software fails to execute. Since the sectors of the distribution media are not easily accessible, the secret codes are difficult to copy. However, modern copying techniques are able to defeat this scheme by making an exact duplicate of the entire CD-ROM or floppy disk, including the secret codes. Also, this scheme can frustrate end users who wish to make legitimate copies of the software, for example for backup purposes.

Various forms of encryption have also been tried, wherein the digital content is stored in an encrypted format, with a variety of hardware or software systems being installed on the end-user's equipment, to decrypt and play the content. For example, manufacturers have tried to install decryption chips into consumer electronics such as videocassette recorders/players, CD players, DVD players, etc. Alternatively, on computerized content playback systems, the decryption routines are provided as computer software, for example in a .DLL or other code file installed on the playback system when the system is manufactured. This code file is accessed by the computer application that is seeking to decrypt the encrypted content, and once the content is decrypted, it is then played, or copied.

These decryption systems, however all suffer from a significant drawback. Since the code that is used to implement the decryption routines is installed onto the end user's device, either as a hardware component (such as on a VCR or DVD player) or as a software module (such as on a computer), this code is fairly easily accessible to the end user. Those seeking to defeat the encryption scheme can therefore more easily reverse-engineer the encryption algorithm, and more easily break the encryption system. Furthermore, once the encryption algorithm is broken, then all content encrypted with the algorithm can then be made accessible merely by distributing a single decoder program. Since most content providers only distribute a single encryption algorithm with their various content, once this algorithm is broken, all of the content is unprotected. Since the decryption routines are installed on the end user's device, the routines are difficult to change, should the content provider wish to implement a different encryption/decryption algorithm. Thus, there is a need for an improved system of preventing unauthorized copying of digital content, while still facilitating legitimate use and copying of the digital content.

### SUMMARY OF THE INVENTION

In an aspect of an embodiment of the invention, an encryption or decryption algorithm is generated on demand by a content provider.

In another aspect of an embodiment of the invention, an encryption or decryption algorithm is provided on demand to a content user.

In another aspect of an embodiment of the invention, an encryption or decryption algorithm is requested by a content user every time the content user wishes to access the encrypted content.

In another aspect of an embodiment of the invention, an encryption or decryption algorithm code is automatically generated on demand by the content provider, using a protocol description.

In another aspect of an embodiment of the invention, the decrypted content is re-encrypted after being accessed, using a different encryption algorithm than the decrypted content was originally encrypted in.

In another aspect of an embodiment of the invention, encryption and decryption algorithms are represented as programmably configurable protocol descriptions.

In another aspect of an embodiment of the invention, the decryption and encryption algorithms are stored in volatile memory on the end user's device, and are deleted after use.

In another aspect of an embodiment of the invention, computer executable code is automatically generated by using a programmably configurable protocol description to configure a protocol parsing engine.

### BRIEF DESCRIPTION OF THE DRAWINGS

In order to better appreciate how the above-recited and other advantages and objects of the present inventions are obtained, a more particular description of the invention briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 depicts a system for securely distributing digital content, in accordance with an embodiment of the invention.

FIG. 2 depicts a content provider of an embodiment of the invention.

FIG. 3 depicts a content user of an embodiment of the invention.

FIG. 4 depicts a computer within a content provider of an embodiment of the invention.

FIG. 5 depicts a media reader within a content user of an embodiment of the invention.

FIG. 6 is a flowchart of a method of operating a content provider to respond to a purchase request from a content user.

FIG. 7 is a flowchart of a method of operating a content user to purchase content.

FIG. 8 is a flowchart of a method of operating a content provider to allow encrypted content to be played by a content user.

FIG. 9 is a flowchart of a method of operating a content user to play encrypted content.

FIG. 10 is a flowchart of a method of operating a content provider to allow an encrypted content item to be copied by a content user.

FIG. 11 is a flowchart of an alternate method of operating a content provider to allow an encrypted content item to be copied by a content user.

FIG. 12 is a flowchart of a method of operating a content user to copy an encrypted content item.

FIG. 13 is a flowchart of an alternate method of operating a content user to obtain a copy of a content item.

### DETAILED DESCRIPTION OF THE PREFERRED EMBODIMENTS

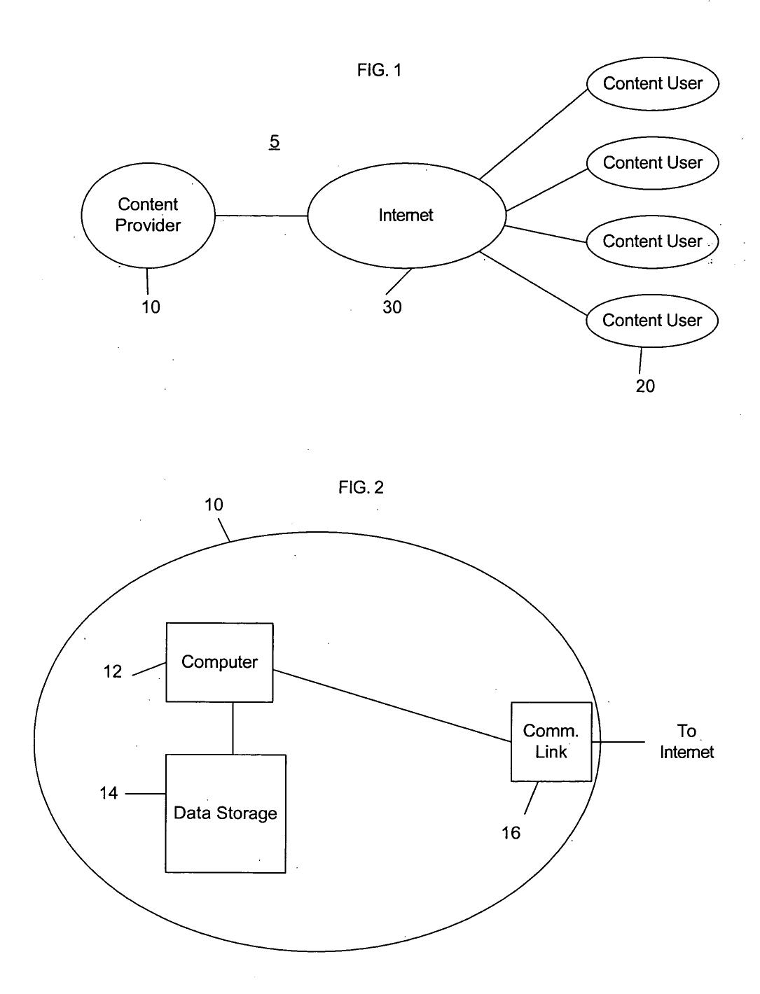

Turning to FIG. 1, in accordance with an embodiment, a system 5 for securely distributing digital content includes a content provider 10, one or more content users 20, and a network 30. The content provider 10 may be any provider of digital content who wishes to keep that content secure. For example, the content provider 10 may be a record company, a movie distribution company, a computer software company, a video rental company, or the like. The content provider 10 may also be a computer or other similar electronic device or collection of devices operated by any of the above enumerated entities. The content user 20 may be any user of digital content, including both natural persons and electronic devices, either being operated by natural persons or operating independently. The network 30 may be any means of establishing communications between the content provider 10 and the content user 20, for the purpose of transferring content between the content provider 10 and the content user 20. For example, the network 30 may be a series of linked computers such as the Internet. Alternatively, the network 30 may be a direct connection between the content provider 10 and the content user 20, such as a wired telephone connection or a wireless link. Alternatively, the content provider 10 and the content user 20 may both reside on the same computer, and the network 30 may be a data path within that computer between the content provider 10 and the content user 20.

Turning to FIG. 2, the content provider 10 of an embodiment includes a computer 12, data storage 14, and a communications link 16. The computer 12 may be any type of computing device that is capable of receiving and processing requests to access digital content. For example, the computer 12 may be a personal computer, a network of personal computers, a server in a client/server model, a mainframe computer, etc. The data storage 14 may be any form of volatile or non-volatile storage medium that is capable of storing digital data. For example, the data storage 14 may be a hard disk, a RAM memory, a RAID array, a WORM drive, an optical disk, a floppy disk, etc. The communications link 16 may be any type of communication device that allows digital data to be transferred into and out of the content provider 10. For example, the communications link 16 may be a network interface card such as an Ethernet card installed in the computer 12, a telephone coupling such as a modem, a wireless radio or cellular telephone coupling, a pager network coupling, a fibre optic channel coupling, etc.

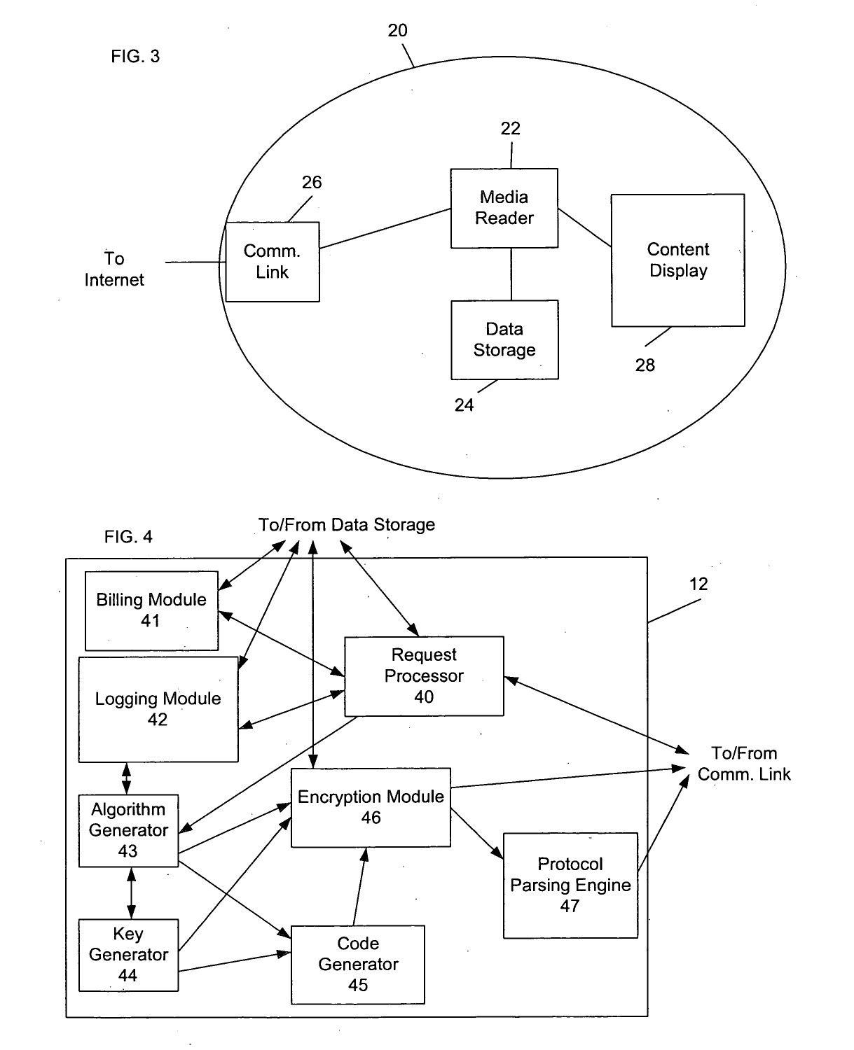

Turning to FIG. 3, the content user 20 of an embodiment includes a media reader 22, a data storage 24, a communications link 26, and a content display 28. The media reader 22 may be any device capable of processing and reading digital media. For example, the media reader 22 may be a personal computer, an MP3 player, a CD player, a DVD player, etc. The data storage 24 may be any form of volatile or non-volatile storage medium that is capable of storing digital data. For example, the data storage 24 may be a hard disk, a RAM memory, a RAID array, a WORM drive, an optical disk, a floppy disk, etc. The communications link 16 may be any type of communication device that allows digital data to be transferred into and out of the content user 20. For example, the communications link 26 may be a network interface card such as an Ethernet card installed in the media reader 22, a telephone coupling such as a modem, a wireless radio or cellular telephone coupling, a pager network coupling, a fibre optic channel coupling, etc. The content display 28 may be any device capable of receiving digital content and displaying it, either in digital or analog or some other format. For example, the content display 28 may be an audio speaker or speaker system, a video monitor, a television set, etc.

Turning to FIG. 4, the computer 12 includes several modules. These modules may be implemented in either software, hardware, firmware, or some combination of software, hardware and firmware. The modules in the computer 12 include a request processor 40, billing module 41, a logging module 42, an algorithm generator 43, a key generator 44, a code generator 45, an encryption module 46 and a protocol parsing engine 47. The modules of computer 12 may also be distributed among multiple computers 12, as desired for more efficient operations.

The request processor 40 receives requests from the content users 20, manages the flow of data between the other modules of the computer 12, and causes outgoing messages and content to be sent to the content users 20. The billing module 41 receives billing information from the content users 20 and interfaces with financial services providers such as banks, credit card companies, etc., in order to ensure that content users 20 have made any necessary payments in order to access the digital content being protected by the system 5. The logging module 42 receives logging requests from the request processor 40, and logs the requests and any other desired information, such as keys or algorithms used to protect content, the status of any request, historical information about the content users 20, and the like, into the data storage 14.

The algorithm generator 43, key generator 44, code generator 45, encryption module 46 and protocol parsing engine 47 work in combination to provide the desired security to protect the digital content being managed by the content provider 10. Many of the elements of and principles behind these modules are discussed in full detail in co-pending U.S. patent application Ser. No. 10/272,471, now U.S. Pat. No. 6,651,102, which reference is hereby incorporated herein by reference, in its entirety. Further elements and principles behind these modules are discussed in full detail in U.S. Pat. No. 6,493,761, U.S. Pat. No. 6,266,700, U.S. Pat. No. 6,000,041, U.S. Pat. No. 5,781,729, and U.S. Pat. No. 5,793,954, all of which are hereby incorporated herein by reference, in their entirety.

Briefly summarizing the operation of these modules, the protocol parsing engine 47 is configured to perform a protocol parsing function, using one or more programmably configurable protocol descriptions. For example, the protocol parsing engine 47 may be configured to perform data modifications such as encrypting and decrypting data, as discussed in U.S. Pat. No. 6,651,102. Alternatively, the protocol parsing engine 47 may be configured to gather statistics, perform routing functions, or modify text formats, as discussed in the various other US patent references incorporated by reference.

The protocol parsing engine 47 uses these programmably configurable protocol descriptions, along with common control logic, to perform the various functions specified by the protocol descriptions. This allows the protocol parsing engine 47 to be re-configured entirely through user input, without the need for hardware or software system modifications. Thus, those skilled in the art with the benefit of this disclosure and the disclosures of the US patents incorporated by reference will appreciate that the system 5 in accordance with an embodiment of the invention may be configured and reconfigured in a highly efficient and cost-effective manner to implement numerous different functions, and to accommodate substantial application or task modifications, such as the use of different types of data processors, different encryption schemes, different encryption algorithms and keys, different key lengths, etc., without requiring substantial system changes.

The protocol parsing engine 47 retrieves input data from either an input data file or a streaming data source such as a network data transmission stream. The input data is typically organized as a series of protocols, such as network transmission protocols. The protocol parsing engine 47 then parses this data, according to the programmably configurable protocol description which was used to configure the protocol parsing engine 47. For example, if the protocol parsing engine 47 is configured with a data modification protocol, then the protocol parsing engine 47 will parse the input data and modify the input data according to the data modification protocol. Thus if the data modification protocol is an encryption protocol, the protocol parsing engine 47 will encrypt the data. Similarly, if the data modification protocol is a decryption protocol, then the protocol parsing engine 47 will decrypt the data. If the protocol parsing engine 47 is configured with a programmably configurable protocol description that includes functions which generate executable code for performing some or all of the configured functions, then the protocol parsing engine 47 will parse the input data using the executable code generated for the protocol parsing engine 47 by the protocol description.

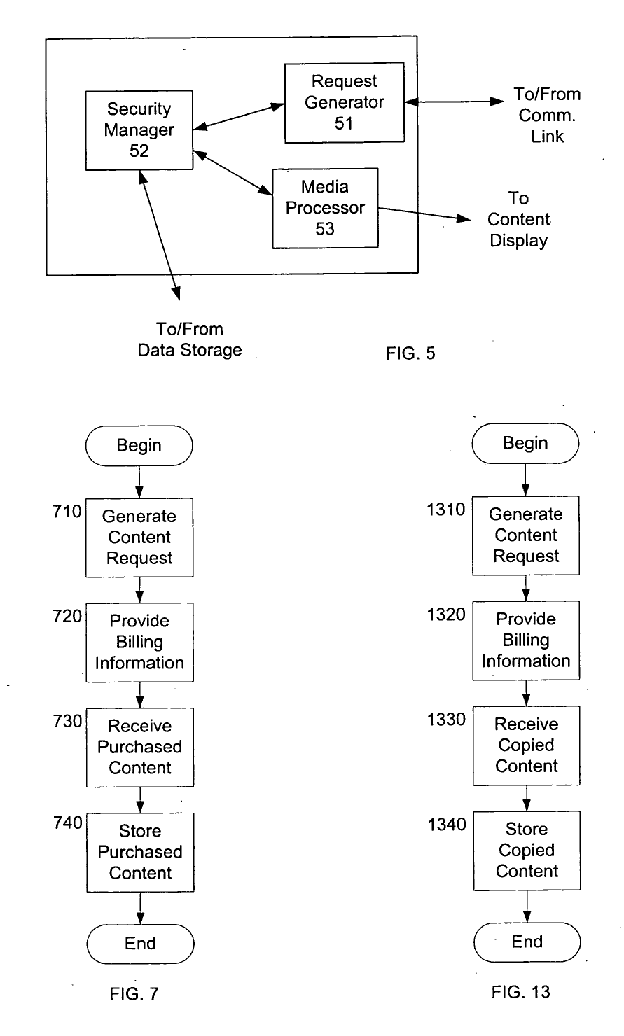

The algorithm generator 43 generates encryption algorithms, either as a stand-alone process, or with the assistance of an administrator. Examples of the encryption algorithms which may be generated by the algorithm generator 43 are the encryption algorithms discussed in U.S. Pat. No. 6,651,102, for example at FIGS. 5-7. Content providers may already have implemented encryption policies or encryption schemes which specify the general parameters for the encryptions to be applied to their data, such as number of transformations, type of transformations, as well as specific algorithms which the content provider prefers. All of this provider-specific customization may be represented in the algorithms generated by the algorithm generator 43, merely by modifying the number of or ordering of the steps of the algorithm, or the values used in the steps of the algorithm, as well as by changing the actual types of modifications to be used in the algorithm. Once an algorithm or scheme has been formulated, then the algorithm generator 43 may be automated, by, for example, instructing the algorithm generator 43 to select the values used in the steps of the algorithm at random, or to re-order the steps of the algorithm according to some configured policy. These algorithms are then expressed as protocol descriptions, to be provided to the protocol parsing engine 47.

The key generator 44 generates keys to be used with the algorithms generated by the algorithm generator 43. These keys may, for example, be used as described in U.S. Pat. No. 6,651,102, along with the algorithms described in that patent, to encrypt or decrypt data. The keys may be generated according to the content provider's key generation policy, which may specify, for example, key lengths or other key requirements such as requiring certain characters in the key, or forbidding certain characters. These keys may be expressed as protocol descriptions, or they may be used by or incorporated into the algorithm generated by the algorithm generator 43. The key generator 44 may be a separate module, or the key generator 44 may be incorporated into the algorithm generator 43.

The encryption module 46 takes the algorithm and key generated by the algorithm generator 43 and key generator 44, and supplies them to the protocol parsing engine 47, thus configuring the protocol parsing engine 47 to encrypt the input data. The encryption module 46 also collects the input data, such as music or video files, from the data storage 14, and supplies the input data to the protocol parsing engine 47.

The code generator 45 takes a the algorithm and key generated by the algorithm generator 43 and key generator 44, uses the algorithm and key to generate executable code for the parsing process, and supplies the generated code to the protocol parsing engine 47, or to the communications link 16, for provision to the security manager 52 on the content user 20. The protocol description for the algorithm and/or key includes, for example, functions that create executable code that when executed will encrypt or decrypt a data file. For example, the protocol description specifies a segment of executable code for each of the possible data manipulation operations that can be specified in a data manipulation protocol description, such as the data manipulation protocol descriptions of FIGS. 5-7 of U.S. Pat. No. 6,651,102. When the protocol description including the executable code is used to configure the protocol parsing engine 47, or the security manager 52, the protocol parsing engine is configured such that, when supplied with a music, video or other content file, it will modify the data in the content file according to the protocol description. The protocol description may also include standardized code routines that are desired to be included into all executable code created by the protocol description. Examples of these standardized code routines would be input/output routines, standardized mathematical computation routines, data cleanup routines, etc.

Turning to FIG. 5, the media reader 22 includes several modules. These modules may be implemented in either software, hardware, firmware, or some combination of software hardware and firmware. The modules in the media reader 22 include a request generator 51, a security manager 52, and a media processor 53.

The request generator 51 is responsible for making requests to the content provider 10 for access to content. The request generator 51 may be implemented in a variety of different manners, depending upon the nature of the media reader 22. For example, if the media reader 22 is a personal computer, the request generator 51 may be a web browser. If the media reader 22 is a portable media player the request generator 51 may be a code routine installed in the firmware of the media player, which responds to a user's activation of a Play button or other such feature of the portable media player. The request generator 51 may be activated by a user of the media reader 22, or the request generator 51 may be activated by other internal processes running on the media reader 22. The request generator 51 sends information to the content provider 10 such as information specifying the identity of the media reader 22, billing information for any charges that the content provider 10 may require, or information about the particular content requested by the media reader 22.

The security manager 52 is responsible for receiving content from the content provider 10. The security manager 52 also manages decrypting encrypted content, and encrypting decrypted content as needed to provide protection to the content from the content provider 10 while allowing the content user 20 to use the content. The security manager 52 receives encrypted content from the content provider 10. The security manager 52 also receives executable encryption and decryption modules from the content provider 10, and executes those modules on decrypted or encrypted content. To further preserve the security of the content provided by the content provider 10, the security manager 52 deletes the executable encryption and decryption modules once those modules have finished operations. Deleting these modules prevents them from being accessed by malicious users of the media reader 22.

The media processor 53 is responsible for processing the decrypted media files created by the security manager 52, and sending the appropriate signals to the content display 28, to display the content. The media processor may include, for example, a digital/analog converter, as well as any other circuitry useful in playing video or audio signal data.

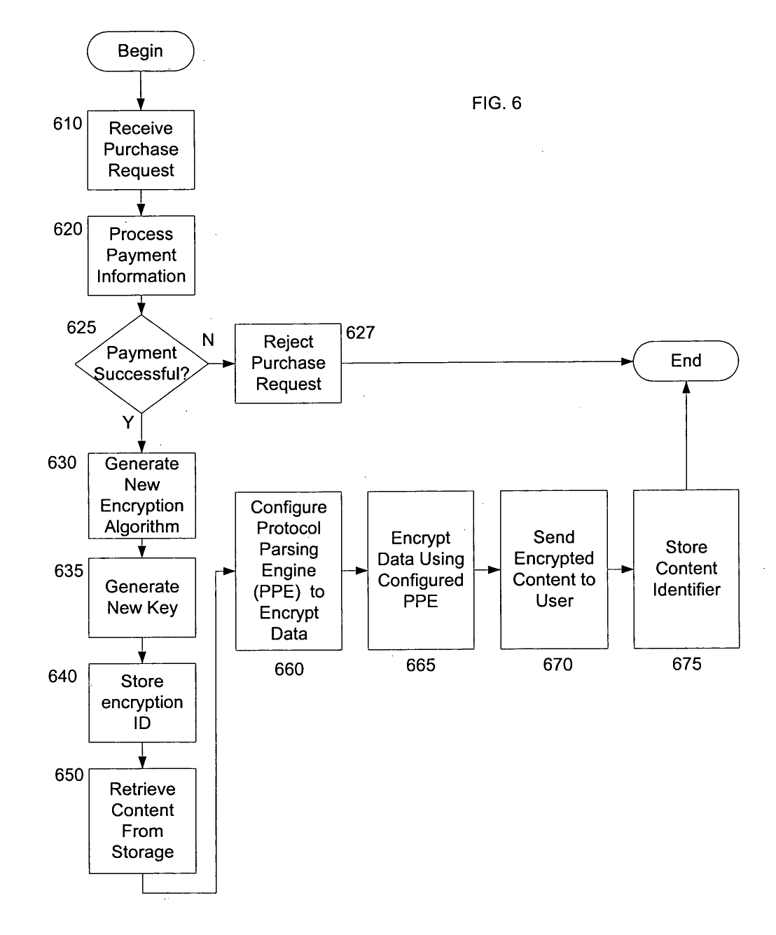

Turning to FIGS. 6-13, the system 5 for securely distributing digital content is used according to various methods, depending on the particular function being performed. Among the functions the system 5 is capable of performing are customer purchases of digital content, customer playing of digital content, and customer copying of digital content. All of these functions are performed while maintaining the security of the digital content from unauthorized copying or playing.

A method of operating a content provider 10 to respond to a purchase request from a content user 20 is shown in FIG. 6. The method begins at step 610 when the content provider 10 receives a purchase request from the content user 20. The purchase request is received over the communications link 16, from the network 30. The purchase request is routed from the communications link 16 to the request processor 40 in the computer 12. At step 620, the request processor 40 routes the request to the billing module 41 to process the content user's payment information. At step 625, if the content user's payment information is not successfully processed and payment is not made, then at step 627 the billing module 41 rejects the purchase request and the request processor 40 advises the content user 20 that the purchase request has been rejected. The rejected purchase request is also sent to the logging module 42 to record the rejected request in the content provider's logs. This information may be useful if the content provider wishes to investigate the logs for patterns of potentially fraudulent conduct, or for other reasons the content provider 10 wishes to learn about the history of requests made to the content provider 10.

If the payment is successfully processed, the request processor 40 routes the purchase request onward through the modules of the computer 12 at the content provider 10. At step 630, in response to the successful purchase request, the algorithm generator 43 generates a new encryption algorithm. As discussed above, this encryption algorithm may be based upon any security policies or schemes the content provider 10 desires to use, depending on the level of security the content provider 10 wishes to implement. In an embodiment, every new purchase request triggers the creation of a new encryption algorithm to be assigned to the specific content being purchased. Alternatively, the content provider 10 may develop a pool of encryption algorithms and select one or more algorithms from this pool for use with the newly purchased content. This alternative solution trades off some loss in security for a simpler operation of the system. The corresponding decryption algorithm may also be generated at this time, if necessary. Alternatively, for many encryption/decryption schemes, the decryption algorithm is easily derived from the encryption algorithm, for example by running the steps of the encryption algorithm in reverse order. For some algorithms, running the steps of the encryption algorithm again, on encrypted content, results in decryption of the content.

Once the encryption algorithm is generated by the algorithm generator 43, then at step 635 a key for the generated algorithm is created by the key generator 44. As noted above, the key generator 44 may be a separate module from the algorithm generator 43, or it may be incorporated into the algorithm generator 43. In an embodiment, every new purchase request triggers the creation of a new encryption key to be assigned to the specific content being purchased. Alternatively, content provider 10 may develop a pool of keys and select one or more keys from this pool for use with the newly purchased content. As a further alternative, an encryption algorithm may be re-used by multiple purchasers of content, with each purchaser being assigned a different key. These alternative solutions trade off some loss in security for a simpler operation of the system.

Either or both of the encryption algorithm and the key may be selected, at least in part, based on information provided by the content user 20. For example, the customer's name, address, credit card number, or a user-selected ID number may be used to partially or fully select the algorithm and key to be used. Alternatively, an algorithm and key may be selected without using any information from the content user 20, and instead the algorithm and key are selected using some internal policies, or random selection.

Once the encryption algorithm and encryption key have been generated, then at step 640 the logging module 42 stores an encryption ID in the data storage 14 at the content provider 10. The encryption ID may comprise the actual algorithm and key themselves, or the encryption ID may comprise some other information sufficient to identify which specific algorithm and key was generated for the newly purchased content. For example, if the algorithm and key are randomly generated, then the encryption ID may be the randomly generated number that was used to select the algorithm and key.

At step 650, the request processor 40 retrieves the newly purchased content from the data storage 14, or from any other data storage where the newly purchased content may be stored, and hands the content off to the encryption module 46. At step 660, the encryption module 46 provides the encryption algorithm and encryption key generated above for the newly purchased content to the protocol parsing engine 47, thereby configuring the protocol parsing engine 47 to encrypt input data according to the encryption algorithm and encryption key provided. Additionally, the code generator 45 generates executable code for any functions specified in the protocol descriptions for the algorithm and key generated above as having executable code for them. The encryption module 46 then provides to the protocol parsing engine 47 these executable code modules, to streamline the encryption process. At step 665, the newly purchased content is provided to the protocol parsing engine 47 as input data, and the newly purchased content is thereby encrypted. Once the content is encrypted, then at step 670 the encrypted content is then sent to the content user 20, along with an identifier identifying the encrypted content. This identifier may be the encryption ID discussed above, if that encryption ID cannot be reverse-engineered or otherwise inspected to extract the encryption algorithm or key. Alternatively the identifier may be some other sequence of data that identifies the specific copy of the content being sent to the content user 20. This identifier is also stored in the data storage 14 by the logging module 42, at step 675.

Since the encryption algorithm and key are both generated on the fly and provided to the configurable protocol parsing engine 47, those skilled in the art will appreciate that the algorithm, the key, and the key length can all be changed each and every time that a content user 20 purchases new content. This allows each copy of each content item sold by the content provider 10 to be encrypted not only with a unique key, but with a unique encryption algorithm, including algorithms with different key lengths.

A method of operating a content user 20 to purchase content is shown in FIG. 7. The method begins at step 710, where the request generator 51 at the content user 20 generates a request to purchase content. Where the request generator 51 is a web browser, the content user 20 enters information such as the title, author, or publisher of desired content. The content user 20 may conduct other activities such as searches for desired content, or reading reviews of content, in addition to requesting the content. Once the content user 20 locates the desired content and is ready to purchase it, then at step 720 the content user 20 provides billing information, such as a credit card number, to the request generator 51. The request generator 51 then forwards all of this information on to the content provider 10, via the communications link 26 and on to the network 30. At step 730 the content user 20 receives the purchased content, in encrypted form as discussed above, from the content provider 10. The encrypted content is stored in the data storage 24, at step 740, where it is made available for future requests to play or copy the content, as will be discussed in detail below.

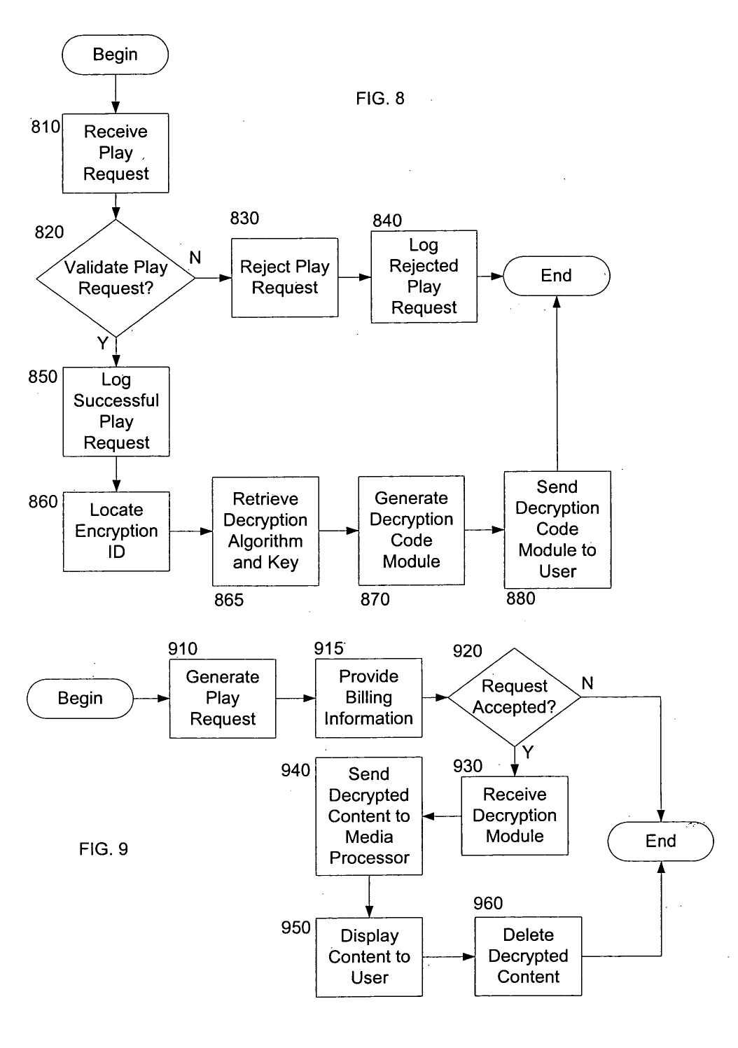

A method of operating a content provider 10 to allow encrypted content to be played by a content user 20 is shown in FIG. 8. The method begins at step 810 when the content provider 10 receives a request to play encrypted content from a content user 20, via the network 30 and communications link 16. The request processor 40 receives the play request, and validates the request at step 820. The request is validated by, for example, comparing an identifier provided by the content user 20 with the corresponding identifier created when the encrypted content was initially purchased by the content user 20. This corresponding identifier is stored at the content provider 10, as discussed at step 675 of FIG. 6. If there is a charge for playing previously purchased content, then a billing procedure similar to that discussed at steps 620-625 of FIG. 6 is followed as part of the validation step. If the content provider 10 cannot validate the play request, then at step 830, the play request is rejected, and the rejection is conveyed back to the content user 20. At step 840, the rejected request is sent to the logging module 42, for logging in the data storage 14. This allows the content provider 10 to keep track of the history of play requests, should the content provider 10 wish to investigate possible fraud attempts or other such issues.

If the validation request is successful, then at step 850, the play request, or the identifier in the play request, is sent to the logging module 42 for logging in the data storage 14. Once the play request is validated, then at step 860 the logging module 42 looks up the encryption ID for the encrypted content that is the subject of the play request, in the data storage 14. The encryption ID is used, at step 865, to retrieve the corresponding decryption algorithm and key for the encrypted content, to allow the encrypted content to be decrypted. The algorithm and key may be retrieved in a variety of ways. For example, if the encryption ID itself contains the decryption algorithm and key, then the algorithm and key are retrieved from the encryption ID itself. If the decryption algorithm and key are stored elsewhere in the data storage 14, indexed by the encryption ID, then the encryption ID is used to locate the decryption algorithm and key stored in the data storage 14. Alternatively, in embodiments where the encryption ID is a seed value for a random selection routine that can be used to generate the decryption algorithm and key, then the decryption algorithm and key are retrieved by providing the encryption ID as a seed to the random selection routine, which results in the decryption algorithm and key being regenerated on demand. Depending on the particular encryption/decryption scheme implemented by the content provider 10, the same seed value will generate both an encryption algorithm and key, as well as the corresponding decryption algorithm and key.

Since the seed value is the same as the original seed value used to create the decryption algorithm and key initially, the re-generated decryption algorithm and key will be identical to the previously created decryption algorithm and key. This alternative embodiment realizes a savings in storage space needed to store all of the algorithms and keys, at the possible tradeoff of increased response time to regenerate algorithms and keys. Note, however, that as the library of generated algorithms and keys becomes larger, regenerating algorithms and keys may eventually be faster than searching for them in the library of generated algorithms and keys.

Once the proper decryption algorithm and key for the content to be played have been recovered, then at step 870 the decryption algorithm and key are passed on to the code generator 45. The code generator 45 uses the decryption algorithm and key to generate an executable code module to allow the security manager 52 on the content user 20 to decrypt the encrypted digital content. Details of the code generation process are discussed below. The code generator 45 can generate code specific to the architecture of the particular media reader 22 at the content user 20, if the play request (or the prior purchase request) contained information sufficient to identify the architecture. For example, if the play or purchase request indicates that the media reader 22 is a Windows/DOS personal computer, then the code generator 45 generates an executable code module for the Windows/DOS architecture. If the play/purchase request indicates that the media reader 22 is an Apple Macintosh personal computer, then the code generator 45 generates an executable code module for the Macintosh architecture. Similarly, if the play/purchase request indicates that the media reader 22 is an iPod device, or a CD player, or an MP3 player, the code generator 45 generates the appropriate executable code module.

The executable code module is only capable of decrypting content that uses the exact decryption algorithm and key provided to the code generator 45. Therefore the executable code module cannot be used by malicious content users 20 as a universal decoder, as long as the content provider 10 has encrypted its content using a variety of different algorithms, as discussed above. In embodiments where every content item sent out from the content provider 10 is encrypted with a different algorithm and key, the executable code module can only be used on the specific content item for which it is intended. Once the executable code module is created by the code generator 45, then at step 880 the executable code module is sent to the content user 20, via the communications link 16 and network 30.

A method of operating a content user 20 to play encrypted content is shown in FIG. 9. The method begins at step 910, where the request generator 51 at the content user 20 generates a request to play content stored in encrypted form on the content user 20. Where the request generator 51 is a web browser, the content user 20 enters information such as the identifier associated with the encrypted content, which was previously provided to the content user 20 when the content user 20 purchased the content item. If there is a charge associated with playing the content item, then at step 915 the content user 20 provides billing information, such as a credit card number, to the request generator 51. The request generator 51 then forwards all of this information on to the content provider 10, via the communications link 26 and on to the network 30.

At step 920, the content user 20 receives a response back from the content provider 10. The request is either denied, if the content provider 10 was unable to validate the request (or process payment if any was required), or the request is accepted and an executable decryption code module is returned to the content user 20. Assuming that the executable decryption code module is returned to the content user 20, the module is provided to the security manager 52, at step 930. In an embodiment, the executable decryption code module is stored in volatile memory on the media reader 22 at the content user 20. Limiting the executable decryption code module to volatile storage helps enhance the security of the system 5, since it is much more difficult for malicious content users 20 to obtain a copy of the executable decryption code module, to possibly inspect or reverse-engineer. The security manager 52 then retrieves the encrypted content item from the data storage 24, or other location where the encrypted content item is stored. Finally, the security manager 52 uses the encrypted content item as input data to the executable decryption code module, and creates a decrypted version of the content item. This decrypted version of the content item is also preferably stored in volatile storage, to minimize the potential for malicious content users 20 to obtain a copy of the decrypted content item. If the content item is too large to be easily stored in volatile memory, then the content item can be decrypted in pieces, each piece being stored in volatile memory until the piece is processed, and then the piece is deleted and replaced with a successive piece of the decrypted content item.

Once the security manager 52 decrypts, or begins decrypting, the content item to be played, at step 940 the decrypted portion of the content item is provided to the media processor 53 for processing. The media processor 53 processes the decrypted content item and routes the output to the content display 28 at step 950, where the content is enjoyed by the content user 20 or others. Once the content item is finished being displayed, or for streaming content items such as audio files, once a portion of the content item stream is finished being displayed, then at step 960 the decrypted content item or portion thereof is deleted from the media reader 22, thereby preserving security of the content item and maintaining the integrity of the system 5.

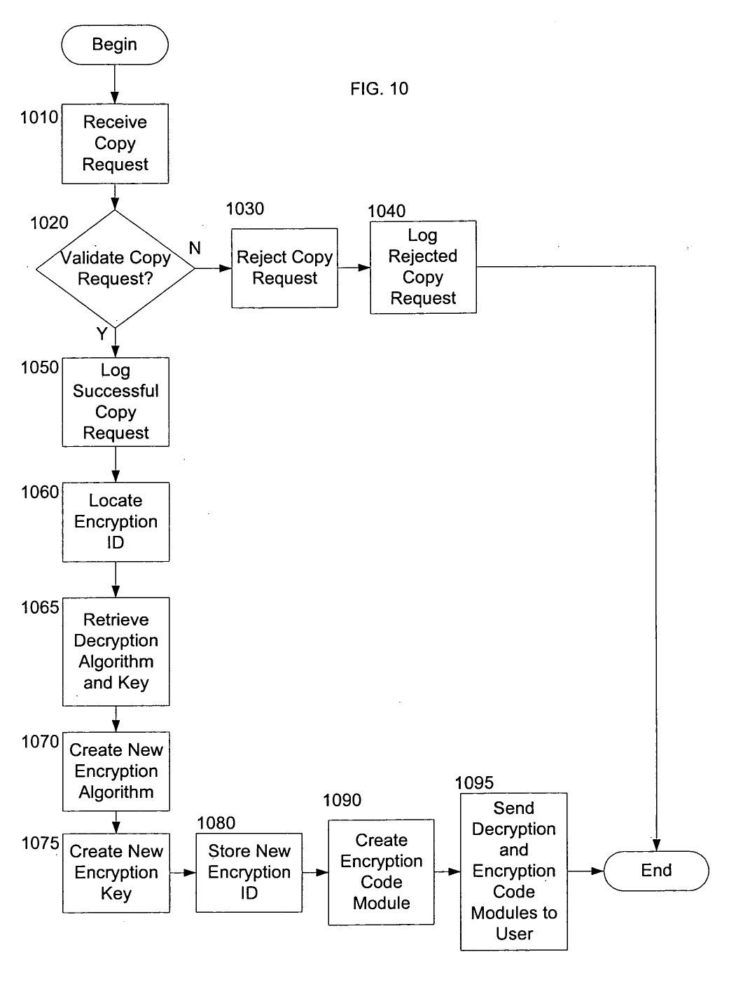

A method of operating a content provider 10 to allow an encrypted content item to be copied by a content user 20 is shown in FIG. 10. The method begins at step 1010 when the content provider 10 receives a request to copy encrypted content from a content user 20, via the network 30 and communications link 16. The request processor 40 receives the copy request, and validates the request at step 1020. The request is validated by, for example, comparing an identifier provided by the content user 20 with the corresponding identifier created when the encrypted content was initially purchased by the content user 20. This corresponding identifier is stored at the content provider 10, as discussed at step 675 of FIG. 6. If there is a charge for copying previously purchased content, then a billing procedure similar to that discussed at steps 620-625 of FIG. 6 is followed as part of the validation step. If the content provider 10 cannot validate the copy request, then at step 1030, the copy request is rejected, and the rejection is conveyed back to the content user 20. At step 1040, the rejected request is sent to the logging module 42, for logging in the data storage 14. This allows the content provider 10 to keep track of the history of copy requests, should the content provider 10 wish to investigate possible fraud attempts or other such issues.

If the validation request is successful, then at step 1050, the copy request, or the identifier in the copy request, is sent to the logging module 42 for logging in the data storage 14. Once the copy request is validated, then at step 1060 the logging module 42 looks up the encryption ID for the encrypted content that is the subject of the copy request, in the data storage 14. The encryption ID is used, at step 1065, to retrieve the corresponding decryption algorithm and key for the encrypted content, to allow the encrypted content to be decrypted. The algorithm and key may be retrieved in a variety of ways, as discussed above for retrieving algorithms and keys for play requests.

Once the decryption algorithm and key are retrieved, then at step 1070, in response to the validated copy request, the algorithm generator 43 generates a new encryption algorithm to be used to encrypt the copy, once it is made. The algorithm generator 43 performs this step in a manner similar to generating new encryption algorithms for newly purchased content, as discussed for step 630 of FIG. 6. Once the encryption algorithm is generated by the algorithm generator 43, then at step 1075 a key for the generated algorithm is created by the key generator 44. The key generation step proceeds similarly to that at step 635 of FIG. 6 above. Once the encryption algorithm and encryption key have been generated, then at step 1080 the logging module 42 stores a new encryption ID in the data storage 14 at the content provider 10 for the new copy. This step is performed in a manner similar to step 640 of FIG. 6 above.

Once the proper decryption algorithm and key for the content to be copied have been recovered, and the new encryption algorithm and key for the new copy have been created, then at step 1090 the decryption algorithm and key are passed on to the code generator 45. The code generator 45 generates an executable code module to configure the security manager 52 at the content user 20 to decrypt the encrypted content item to be copied. This process is performed in a manner similar to step 870 of FIG. 8 above. The code generator 45 then generates an executable code module to configure the security manager 52 at the content user 20 to encrypt the new copy of the content item that is about to be created. This process is performed in a manner similar to step 870 of FIG. 8 above, except that the executable encryption code module will encrypt rather than decrypt the content item provided as input. Once the two executable code modules are created by the code generator 45, then at step 1095, the executable code modules are sent to the content user 20, via the communications link 16 and network 30.

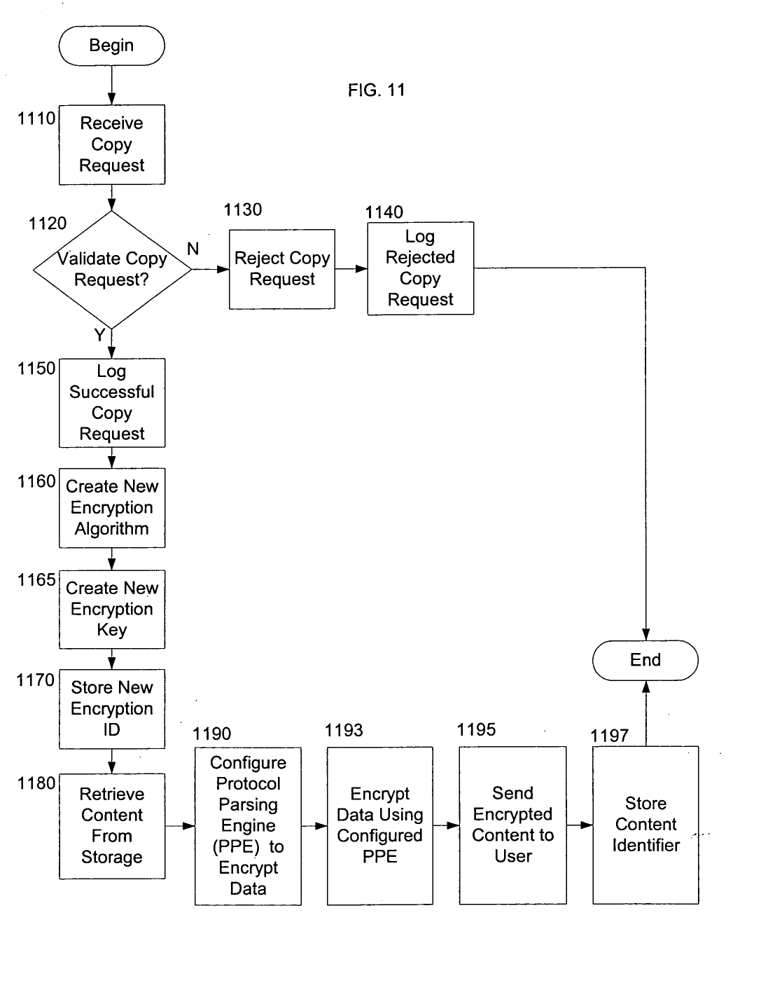

An alternative method of operating a content provider 10 to allow an encrypted content item to be copied by a content user 20 is shown in FIG. 11. This method performs the copying and encryption steps at the content provider 10 instead of at the content user 20. Security is thereby enhanced, at a tradeoff of increased network bandwidth usage, increased demand on the computer 12 at the content provider 10, and increased storage requirements for the data storage 14, since it must store a master copy of all content ever sold, not just a current catalog of content for sale.

The method begins at step 1110 when the content provider 10 receives a request to copy encrypted content from a content user 20, via the network 30 and communications link 16. The request processor 40 receives the copy request, and validates the request at step 1120. The request is validated by, for example, comparing an identifier provided by the content user 20 with the corresponding identifier created when the encrypted content was initially purchased by the content user 20. This corresponding identifier is stored at the content provider 10, as discussed at step 675 of FIG. 6. If there is a charge for copying previously purchased content, then a billing procedure similar to that discussed at steps 620-625 of FIG. 6 is followed as part of the validation step. If the content provider 10 cannot validate the copy request, then at step 1130, the copy request is rejected, and the rejection is conveyed back to the content user 20. At step 1140, the rejected request is sent to the logging module 42, for logging in the data storage 14. This allows the content provider 10 to keep track of the history of copy requests, should the content provider 10 wish to investigate possible fraud attempts or other such issues.

If the validation request is successful, then at step 1150, the copy request, or the identifier in the copy request, is sent to the logging module 42 for logging in the data storage 14. Then at step 1160, in response to the validated copy request, the algorithm generator 43 generates a new encryption algorithm to be used to encrypt the copy, once it is made. The algorithm generator 43 performs this step in a manner similar to generating new encryption algorithms for newly purchased content, as discussed for step 630 of FIG. 6. Once the encryption algorithm is generated by the algorithm generator 43, then at step 1165 a key for the generated algorithm is created by the key generator 44. The key generation step proceeds similarly to that at step 635 of FIG. 6 above. Once the encryption algorithm and encryption key have been generated, then at step 1170 the logging module 42 stores a new encryption ID in the data storage 14 at the content provider 10 for the new copy. This step is performed in a manner similar to step 640 of FIG. 6 above.

At step 1180, the request processor 40 retrieves the content to be copied from the data storage 14, or from any other data storage where the content to be copied may be stored, and hands the content off to the encryption module 46. At step 1190, the encryption module 46 provides the encryption algorithm and encryption key generated above for the content to be copied to the protocol parsing engine 47, thereby configuring the protocol parsing engine 47 to encrypt input data according to the encryption algorithm and encryption key provided. Additionally, the code generator 45 generates executable code for any functions specified in the protocol descriptions for the algorithm and key generated above as having executable code for them. The encryption module 46 then provides to the protocol parsing engine 47 these executable code modules, to streamline the encryption process. At step 1193, the content to be copied is provided to the protocol parsing engine 47 as input data, and the content to be copied is thereby encrypted. Once the content is encrypted, then at step 1195 the encrypted content is sent to the content user 20, along with an identifier identifying the encrypted content. This identifier may be the encryption ID discussed above, if that encryption ID cannot be reverse-engineered or otherwise inspected to extract the encryption algorithm or key. Alternatively the identifier may be some other sequence of data that identifies the specific copy of the content being sent to the content user 20. This identifier is also stored in the data storage 14 by the logging module 42, at step 1197.

Since the encryption algorithm and key are both generated on the fly and provided to the configurable protocol parsing engine 47, those skilled in the art will appreciate that the algorithm, the key, and the key length can all be changed each and every time that a content user 20 makes a copy of content. This allows each copy of each content item sold by the content provider 10 to be encrypted not only with a unique key, but with a unique encryption algorithm, including algorithms with different key lengths.

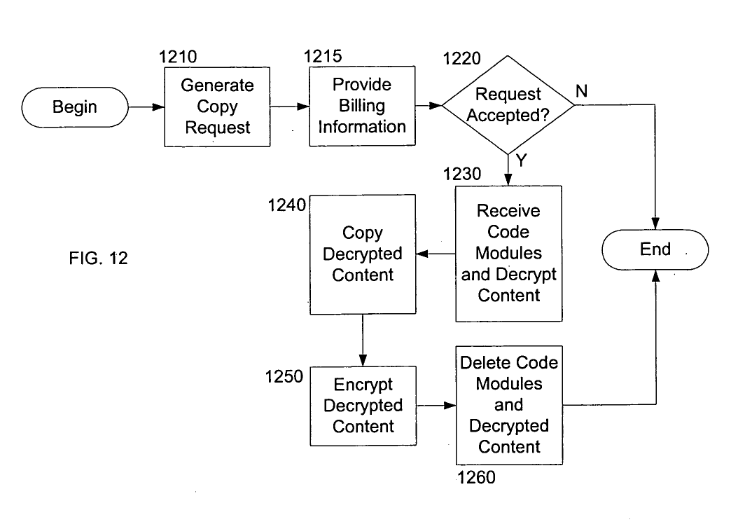

A method of operating a content user 20 to copy an encrypted content item 20 is shown in FIG. 12. The method begins at step 1210, where the request generator 51 at the content user 20 generates a request to copy content stored in encrypted form on the content user 20. Where the request generator 51 is a web browser, the content user 20 enters information such as the identifier associated with the encrypted content, which was previously provided to the content user 20 when the content user 20 purchased the content item. If there is a charge associated with copying the content item, then at step 1215 the content user 20 provides billing information, such as a credit card number, to the request generator 51. The request generator 51 then forwards all of this information on to the content provider 10, via the communications link 26 and on to the network 30.

At step 1220, the content user 20 receives a response back from the content provider 10. The request is either denied, if the content provider 10 was unable to validate the request (or process payment if any was required), or the request is accepted and an executable decryption code module and executable encryption code module are returned to the content user 20. Assuming that the executable decryption and encryption code modules are returned to the content user 20, the modules are provided to the security manager 52, at step 1230. In an embodiment, the executable decryption and encryption code modules are stored in volatile memory on the media reader 22 at the content user 20. Limiting the executable decryption and encryption code modules to volatile storage helps enhance the security of the system 5, since it is much more difficult for malicious content users 20 to obtain a copy of the executable decryption and encryption code modules, to possibly inspect or reverse-engineer them. The security manager 52 then retrieves the encrypted content item from the data storage 24, or other location where the encrypted content item is stored. The security manager 52 uses the encrypted content item as input data to the executable decryption code module, and creates a decrypted version of the content item. This decrypted version of the content item is also preferably stored in volatile storage, to minimize the potential for malicious content users 20 to obtain a copy of the decrypted content item. If the content item is too large to be easily stored in volatile memory, then the content item can be decrypted in pieces, each piece being stored in volatile memory until the piece is processed, and then the piece is deleted and replaced with a successive piece of the decrypted content item.

Once the encrypted content item is decrypted, or as it is decrypted, the decrypted content item is copied by the media processor 53, at step 1240. The decrypted copy is also preferably stored in volatile memory, such as the RAM of the media reader 22, as discussed above. The decrypted copy is then provided as input to the executable encryption code module, at step 1250. This results in a newly encrypted copy of the content item being created, using the new algorithm and key contained in the executable encryption code module. Thus the original and the copy both remain on the content user 22, but they are both encrypted, using different algorithms and keys. The encrypted copy may now be freely distributed to another content user 20, or burned into a CD-ROM or DVD media disk, or the like, without fear that the content user 20 will be able to create further unencrypted copies. The second content user 20 may still play the copy of the content, by making his own play request to the content provider 10. At step 1260, the executable encryption and decryption code modules and the decrypted content are all deleted from the memory they were stored in.

An alternative method of operating a content user 20 to obtain a copy of a content item is shown in FIG. 13. This method performs the copying and encryption steps at the content provider 10 instead of at the content user 20. Security is thereby enhanced, and processing resources at the content user 20 are conserved, at a tradeoff of increased network bandwidth usage, increased demand on the computer 12 at the content provider 10, and increased storage requirements for the data storage 14, since it must store a master copy of all content ever sold, not just a current catalog of content for sale. From the point of view of the content user 20, the method is treated identically to a purchase of new content, except that an identifier is sent to the content provider 10 to establish that the content user 20 is already in possession of a copy of the content item. This information may be used by the content provider to, for example, make billing decisions (i.e. billing a content user 20 at a lower rate, or dispensing with billing entirely, for copies of content that the content user 20 already owns).

The method begins at step 1310, where the request generator 51 at the content user 20 generates a request to copy an identified content item. At step 720 the content user 20 provides billing information if required by the content provider 10. The request generator 51 then forwards all of this information on to the content provider 10. At step 730 the content user 20 receives the copied content, in encrypted form as discussed above, from the content provider 10. The encrypted content is stored in the data storage 24, at step 740, where it is made available for future requests to play or copy the content.

It is possible that someone will make copies of an encrypted content item and distribute those copies. Each of these users may then make play requests, asking for permission to play their illicit copy. This can be easily thwarted, however, by using the methods discussed above to change the algorithm and key associated with any content item, each time a-play request is made. With such a scheme, the first content user 20 to request to play any particular encrypted copy will be accepted, and his copy of the encrypted content will be re-encrypted after it is played. All successive content users 20, however, will be rejected, since either their identifiers will no longer match the identifier on file (which was changed when the first content user 20 made a play request) or else the encrypted file will not be able to be unencrypted, since the decryption algorithm and key were changed by the first content user 20 when he made the first play request. Effectively, this alternate embodiment combines a copy request with every play request, creating true one-use copies of content items.

Code Generation

A detailed discussion of the use of the protocol description to generate executable code will now be presented. To aid in understanding these examples, a framework within the instruction set of the target machine and language will be defined. The following discussion assumes that the target machine is an x86 style Intel processor and the target language is the x86 assembly language. It is possible to produce code (programming instructions) for virtually any processor or other programmable device. For instance, the example code detailed below could be changed to output machine code directly so that it is ready to be executed without needing to be assembled first. Additionally, the filtering code examples shown below could be modified to produce programming instructions/configuration information suitable for the content addressable memory typically used to perform rudimentary frame filtering in many network switches and routers.

The x86 processor provides 8 32-bit general-purpose registers: EAX, EBX, ECX, EDX, EBP, ESP, ESI, and EDI. The low 16 bits of the 32-bit general-purpose registers can be referenced independently as AX, BX, CX, DX, BP, SP, SI, AND DI. Each byte of the first four 16 bit registers can be referenced independently as AH, BH, CH, DH for the high bytes, and AL, BL, CL, DL for the low bytes.

Code can be optimized and memory accesses performed by the processor can be minimized by making assumptions and pre-assigning both meanings and values to registers that will apply to all generated code. The following discussions assume that:

1. The ESI register will contain a pointer to the start of the protocol header currently being parsed (i.e. code being generated for); therefore ESI=ParsePtr as that term is used in U.S. Pat. No. 6,651,102 and the other US patents incorporated by reference herein.

2. 64-bit values returned from any operation will be contained in EDX:EAX, where EDX contains the upper 32 bits and EAX contains the lower 32 bits.

3. 32-bit values returned from any operation will be contained in EAX, the contents of EDX are undefined.

TABLE 1
Basic Generated Code Output Routine.

```
U32 NextLabelNumber = 0; // For generating Label Names
char codebuf[262144];
void OutText(char *Instruction, U32 v1, U32 v2, protocol *p,
field *f, char *Comment)
{
if (Instruction != “”)
  sprintf(&codebuf[strlen(codebuf)], Instruction, v1, v2, p);
// Output user supplied instruction and 1,2, or 3 values
else
  {
  sprintf(&codebuf[strlen(codebuf)], “;\n”); // Output newline
character
  if (p != 0 && p->pname( ) != “”)
    sprintf(&codebuf[strlen(codebuf)], “; (%s)”, p-
>pname( )); // Output protocol name
  if (f != 0 && f->name( ) != “”)
    sprintf(&codebuf[strlen(codebuf)], “->(%s)”, f->name( ));
// Output field name
  if (Comment != “”)
    sprintf(&codebuf[strlen(codebuf)], “%s”, Comment); //
Output any supplied comment
  sprintf(&codebuf[strlen(codebuf)], “\n;”); // Output newline
character
  }
sprintf(&codebuf[strlen(codebuf)], “\n”); // Output newline
character
}
```

The code in Table 1 is an example of code used by the code generation routines below, to send the actual lines of generated code to an output buffer, which may be a data file or may be some other output processing routine.

The routine in Table 2 below generates optimized code for extracting values for user defined protocol fields. The routine uses data from a protocol record to select which of the code templates included in the routine to send to the output buffer. The code templates are combined with data from the protocol record to generate customized code. Only the portion of the code that generates extraction code for fields that are aligned on an 8-bit boundary in memory is shown. The code for extracting values for fields that are not aligned has been removed because it is not used in any of the included examples.

TABLE 2
Example Field Value Extraction Code Generation Routine

```
//
//  esi - ParsePtr
//  edx:eax - extracted field value
//
void field::GenerateFieldExtractionCode(protocol *p, U32
IncludeUpper32)
{
U32 BitLen = 64 − fshr, FirstBit = fshl, LastBit = fshl + BitLen
− 1;
U32 HiMask = (U32)((0xffffffffffffffff<<fshl)>>(fshr+32)),
LoMask = (U32)((0xffffffffffffffff<<fshl)>>fshr);
//
U64 Msk = (0xffffffffffffffff<<fshr)>>fshl;
if (BitLen == 0)
  return;
sprintf(&codebuf[strlen(codebuf)], “;\n;..........<<%u
>>%u::%u\n;..........0x%08X%08X\n;\n”,
  fshl, fshr, BitLen, (U32)(Msk>>32), (U32)Msk&0xffffffff);
//
// Optimized extraction cases done first
//
if (BitLen <= 8) // Len <= 8 bits ?
  {
  if (FirstBit/8 == LastBit/8) // All bits in one byte ?
    {
    if (IncludeUpper32)
      OutText(“ xor  edx, edx”);
    OutText (“ xor  eax, eax”);
    OutText(“ mov  al, BYTE PTR [esi+%u]”, p-
>swap( ) ? fdwoff+fshl/8 : fdwoff+(fshr−fshl)/8);
    if (((fshl+BitLen)&7) != 0)
      OutText(“ shr  al, %u”, (fshr−
fshl)&7); // Signed case ... use sar
    if ((fshl&7) != 0)
      OutText(“ and  al, BYTE PTR %02xH”,
LoMask);
    return;
    }
  }
else
  if ((fshl&7) == 0) // Does this field start on a BYTE
boundary?
    {
    if (fshr == 48) // WORD ??
      {
      if (IncludeUpper32)
        OutText(“ xor  edx, edx”);
      OutText(“ xor  eax, eax”);
      if (p->swap( ))
        {
        OutText(“ mov  ah, BYTE PTR
[esi+%u]”, fdwoff+fshl/8);
        OutText(“ mov  al, BYTE PTR
[esi+%u]”, fdwoff+fshl/8+1);
        }
      else
        OutText(“ mov  ax, WORD PTR
[esi+%u]”, fdwoff+fshl/8);
      return;
      }
    else
      if (fshr == 40) // BYTE AND WORD ?
        {
        if (IncludeUpper32)
          OutText(“ xor  edx, edx”);
        if (p->swap( ))
          {
          OutText(“ mov  eax, DWORD PTR
[esi+%u]”, fdwoff+fshl/8−1);
          OutText(“ bswap  eax”);
          OutText(“ and  eax, DWORD PTR
%09xH”, LoMask);
          }
        else
          {
          OutText(“ mov  eax, DWORD PTR
[esi+%u]”, fdwoff+(fshr−fshl)/8);
          OutText(“ and  eax, DWORD PTR
%09xH”, LoMask);
          }
        return;
        }
      else
        if (fshr == 32) // DWORD ?
          {
          if (IncludeUpper32)
            OutText(“ xor  edx, edx”);
        if (p->swap( ))
          {
          OutText(“ mov  eax, DWORD
PTR [esi+%u]”, fdwoff+fshl/8);
          OutText(“ bswap  eax”);
          }
        else
          OutText(“ mov  eax, DWORD
PTR [esi+%u]”, fdwoff+(fshr−fshl)/8);
        return;
        }
      else
        if (fshr == 24) // BYTE AND DWORD ?
          {
          OutText (“ xor  edx, edx”);
          if (p->swap( ))
            {
            OutText(“ mov  eax,
DWORD PTR [esi+%u]”, fdwoff+fshl/8+1);
            OutText(“ mov  dl,
BYTE PTR [esi+%u]”, fdwoff+fshl/8+0);
            OutText(“ bswap  eax”);
            }
          else
            {
            OutText (“ mov  eax,
DWORD PTR [esi+%u]”, fdwoff+(fshr−fshl)/8);
            OutText(“ mov  dl,
BYTE PTR [esi+%u]”, fdwoff+(32+fshr−fshl)/8);
            }
          return;
          }
        else
          if (fshr == 16) // WORD AND DWORD ?
            {
            OutText(“ xor  edx,
edx”);
            if (p->swap( ))
              {
              OutText(“ mov
eax, DWORD PTR [esi+%u]”, fdwoff+fshl/8+2);
              OutText(“ mov  dl,
BYTE PTR [esi+%u]”, fdwoff+fshl/8+1);
              OutText(“ mov  dh,
BYTE PTR [esi+%u]”, fdwoff+fshl/8);
              OutText(“ bswap
eax”);
            }
          else
            {
            OutText(“ mov
eax, DWORD PTR [esi+%u]”, fdwoff+(fshr−fshl)/8);
            OutText(“ mov  dx,
WORD PTR [esi+%u]”, fdwoff+(32+fshr−fshl)/8);
            }
          return;
          }
      else
        if (fshr == 8) // BYTE AND WORD AND
DWORD ?
          {
          if (p->swap( ))
            {
            OutText(“ mov
edx, DWORD PTR [esi+%u]”, fdwoff+fshl/8−1);
            OutText(“ mov
eax, DWORD PTR [esi+%u]”, fdwoff+fshl/8+3);
            OutText(“ bswap
edx”);
            OutText(“ bswap
eax”);
            OutText(“ and
edx, DWORD PTR %09xH”, HiMask);
            }
          else
            {
            OutText(“ mov
eax, DWORD PTR [esi+%u]”, fdwoff+(fshr−fshl)/8);
            OutText(“ mov
edx, DWORD PTR [esi+%u]”, fdwoff+(32+fshr−fshl)/8);
            OutText(“ and
edx, DWORD PTR %09xH”, HiMask);
            }
          return;
          }
        else
          if (fshr == 0) // DWORD AND DWORD ?
            {
            if (p->swap( ))
              {
              OutText(“ mov
edx, DWORD PTR [esi+%u]”, fdwoff+0);
              OutText(“ mov
eax, DWORD PTR [esi+%u]”, fdwoff+4);
              OutText(“ bswap
edx”);
              OutText(“ bswap
eax”);
              }
            else
              {
              OutText(“ mov
eax, DWORD PTR [esi+%u]”, fdwoff+0);
              OutText(“ mov
edx, DWORD PTR [esi+%u]”, fdwoff+4);
              }
            return;
            }
    }
//
// Unoptimized cases removed...field does not start on a byte
boundary
//
}
```

The code in Table 3 below uses the code from Table 2 to generate the code in Table 4 below, showing all 36 possible values with a length that is a multiple of 8 bits and is aligned on an 8-bit boundary in memory within a 64 bit field. The code in Table 3 creates a series of fields containing field values, via the nested loops (fshr, fshl). The field values are used as input to the code in Table 2, to generate the output of Table 4.

TABLE 3
Routine to Create Sample Fields to Generate Code For

```
for (int r=56; r>=0; r−=8) // fshr
  {
  for (int l=r; l>=0; l−=8) // fshl
    {
//
//  Construct a field entity of length (64−r)
//  with its first bit located “l” bits from the
left of a 64 bit field
//  and with its last bit located “l” - (64 − “r”) bits
from the right of a 64 bit field
//
    field ff(“IHL”, // field name
          l, // bits to shift left
          r, // bits to shift right
        64−r, // field bitsize
          0, // pointer to any associated lookup
class
          0 // pointer to any associated statistics
class
        );
ff.GenerateFieldExtractionCode(&p, TRUE);
    }
  }
//
//  Save generated text to file “c:\pa_mdi\ASM”
//
FILE *TxtFile;
if ((TxtFile = fopen(“c:\\pa_mdi\\ASM”, “wt”) )!= NULL)
  {
  fwrite(codebuf,  1, strlen(codebuf), TxtFile);
  fclose(TxtFile);
  }
```

The generated code is presented in Table 4 below. The field value extraction code shown below is code that, when executed on input data, will pull out a field value from within that input data, according to the field length and field location within the data as specified by the generated code. The comments in the code in Table 4 uses the following nomenclature for the 36 generated code examples:

```
  ;..........<<48 >>56::8  // Shift left 48 bits;
Then shift Right 56 bits to produce
  ;..........0x000000000000FF00 // an 8 bit value right
justified in a 64 bit field
```

For example, the above code comment will extract an 8-bit value, located at bits 11-15, from a 64-bit field.

Note that [esi+4294967295] is equivalent to [esi-1] in the generated code samples of Table 4. Also note the bswap instruction changes the order of bytes in a 32 bit word (4 bytes) from 4321 to 1234 in the referenced register and is an instruction provided by the x86 architecture. Also note that byte order that data is transmitted on most networks is backwards from the order that the x86 architecture stores it in memory. This makes the bswap instruction necessary in instances where the byte order is important, such as when a filter criteria specifies a range of values. In the case of a filter criteria that only specifies a single value, the comparison value can be swapped as the code is generated to eliminate the bswap instruction.

TABLE 4
Example Generated Field Value Extraction Code for Common Cases

| // | |
|---|---|
| // Generated code for 36 possible aligned cases | |
| // | |
| ; | |
| ;..........<<56 >>56::8 | |
| ;..........0x00000000000000FF | |
| xor | edx, edx |
| xor | eax, eax |
| mov | al, BYTE PTR [esi+7] |
| ; | |
| ;..........<<48 >>56::8 | |
| ;..........0x000000000000FF00 | |
| ; | |
| xor | edx, edx |
| xor | eax, eax |
| mov | al, BYTE PTR [esi+6] |
| ; | |
| ;..........<<40 >>56::8 | |
| ;..........0x0000000000FF0000 | |
| ; | |
| xor | edx, edx |
| xor | eax, eax |
| mov | al, BYTE PTR [esi+5] |
| ; | |
| ;..........<<32 >>56::8 | |
| ;..........0x00000000FF000000 | |
| ; | |
| xor | edx, edx |
| xor | eax, eax |
| mov | al, BYTE PTR [esi+4] |
| ; | |
| ;..........<<24 >>56::8 | |
| ;..........0x000000FF00000000 | |
| ; | |
| xor | edx, edx |
| xor | eax, eax |
| mov | al, BYTE PTR [esi+3] |
| ; | |
| ;..........<<16 >>56::8 | |
| ;..........0x0000FF0000000000 | |
| ; | |
| xor | edx, edx |
| xor | eax, eax |
| mov | al, BYTE PTR [esi+2] |
| ; | |
| ;..........<<8 >>56::8 | |
| ;..........0x00FF000000000000 | |
| ; | |
| xor | edx, edx |
| xor | eax, eax |
| mov | al, BYTE PTR [esi+1] |
| ; | |
| ;..........<<0 >>56::8 | |
| ;..........0xFF00000000000000 | |
| ; | |
| xor | edx, edx |
| xor | eax, eax |
| mov | al, BYTE PTR [esi+0] |
| ; | |
| ;..........<<48 >>48::16 | |
| ;..........0x000000000000FFFF | |
| ; | |
| xor | edx, edx |
| xor | eax, eax |
| mov | ah, BYTE PTR [esi+6] |
| mov | al, BYTE PTR [esi+7] |
| ; | |
| ;..........<<40 >>48::16 | |
| ;..........0x0000000000FFFF00 | |
| ; | |
| xor | edx, edx |
| xor | eax, eax |
| mov | ah, BYTE PTR [esi+5] |
| mov | al, BYTE PTR [esi+6] |
| ; | |
| ;..........<<32 >>48::16 | |
| ;..........0x00000000FFFF0000 | |
| ; | |
| xor | edx, edx |
| xor | eax, eax |
| mov | ah, BYTE PTR [esi+4] |
| mov | al, BYTE PTR [esi+5] |
| ; | |
| ;..........<<24 >>48::16 | |
| ;..........0x000000FFFF000000 | |
| ; | |
| xor | edx, edx |
| xor | eax, eax |
| mov | ah, BYTE PTR [esi+3] |
| mov | al, BYTE PTR [esi+4] |
| ; | |
| ;..........<<16 >>48::16 | |
| ;..........0x0000FFFF00000000 | |
| ; | |
| xor | edx, edx |
| xor | eax, eax |
| mov | ah, BYTE PTR [esi+2] |
| mov | al, BYTE PTR [esi+3] |
| ; | |
| ;..........<<8 >>48::16 | |
| ;..........0x00FFFF0000000000 | |
| ; | |
| xor | edx, edx |
| xor | eax, eax |
| mov | ah, BYTE PTR [esi+1] |
| mov | al, BYTE PTR [esi+2] |
| ; | |
| ;..........<<0 >>48::16 | |
| ;..........0xFFFF000000000000 | |
| ; | |
| xor | edx, edx |
| xor | eax, eax |
| mov | ah, BYTE PTR [esi+0] |
| mov | al, BYTE PTR [esi+1] |
| ; | |
| ;..........<<40 >>40::24 | |
| ;..........0x0000000000FFFFFF | |
| ; | |
| xor | edx, edx |
| mov | eax, DWORD PTR [esi+4] |
| bswap | eax |
| and | eax, DWORD PTR 000ffffffH |
| ; | |
| ;..........<<32 >>40::24 | |
| ;..........0x00000000FFFFFF00 | |
| ; | |
| xor | edx, edx |
| mov | eax, DWORD PTR [esi+3] |
| bswap | eax |
| and | eax, DWORD PTR 000ffffffH |
| ; | |
| ;..........<<24 >>40::24 | |
| ;..........0x000000FFFFFF0000 | |
| ; | |
| xor | edx, edx |
| mov | eax, DWORD PTR [esi+2] |
| bswap | eax |
| and | eax, DWORD PTR 000ffffffH |
| ; | |
| ;..........<<16 >>40::24 | |
| ;..........0x0000FFFFFF000000 | |
| ; | |
| xor | edx, edx |
| mov | eax, DWORD PTR [esi+1] |
| bswap | eax |
| and | eax, DWORD PTR 000ffffffH |
| ; | |
| ;..........<<8 >>40::24 | |
| ;..........0x00FFFFFF00000000 | |
| ; | |
| xor | edx, edx |
| mov | eax, DWORD PTR [esi+0] |
| bswap | eax |
| and | eax, DWORD PTR 000ffffffH |
| ; | |
| ;..........<<0 >>40::24 | |
| ;..........0xFFFFFF0000000000 | |
| ; | |
| xor | edx, edx |
| mov | eax, DWORD PTR [esi+4294967295] |
| bswap | eax |
| and | eax, DWORD PTR 000ffffffH |
| ; | |
| ;..........<<32 >>32::32 | |
| ;..........0x00000000FFFFFFFF | |
| ; | |
| xor | edx, edx |
| mov | eax, DWORD PTR [esi+4] |
| bswap | eax |
| ; | |
| ;..........<<24 >>32::32 | |
| ;..........0x000000FFFFFFFF00 | |
| ; | |
| xor | edx, edx |
| mov | eax, DWORD PTR [esi+3] |
| bswap | eax |
| ; | |
| ;..........<<16 >>32::32 | |
| ;..........0x0000FFFFFFFF0000 | |
| ; | |
| xor | edx, edx |
| mov | eax, DWORD PTR [esi+2] |
| bswap | eax |
| ; | |
| ;..........<<8 >>32::32 | |
| ;..........0x00FFFFFFFF000000 | |
| ; | |
| xor | edx, edx |
| mov | eax, DWORD PTR [esi+1] |
| bswap | eax |
| ; | |
| ;..........<<0 >>32::32 | |
| ;..........0xFFFFFFFF00000000 | |
| ; | |
| xor | edx, edx |
| mov | eax, DWORD PTR [esi+0] |
| bswap | eax |
| ; | |
| ;..........<<24 >>24::40 | |
| ;..........0x000000FFFFFFFFFF | |
| ; | |
| xor | edx, edx |
| mov | eax, DWORD PTR [esi+4] |
| mov | dl, BYTE PTR [esi+3] |
| bswap | eax |
| ; | |
| ;..........<<16 >>24::40 | |
| ;..........0x0000FFFFFFFFFF00 | |
| ; | |
| xor | edx, edx |
| mov | eax, DWORD PTR [esi+3] |
| mov | dl, BYTE PTR [esi+2] |
| bswap | eax |
| ; | |
| ;..........<<8 >>24::40 | |
| ;..........0x00FFFFFFFFFF0000 | |
| ; | |
| xor | edx, edx |
| mov | eax, DWORD PTR [esi+2] |
| mov | dl, BYTE PTR [esi+1] |
| bswap | eax |
| ; | |
| ;..........<<0 >>24::40 | |
| ;..........0xFFFFFFFFFF000000 | |
| ; | |
| xor | edx, edx |
| mov | eax, DWORD PTR [esi+1] |
| mov | dl, BYTE PTR [esi+0] |
| bswap | eax |
| ; | |
| ;..........<<16 >>16::48 | |
| ;..........0x0000FFFFFFFFFFFF | |
| ; | |
| xor | edx, edx |
| mov | eax, DWORD PTR [esi+4] |
| mov | dl, BYTE PTR [esi+3] |
| mov | dh, BYTE PTR [esi+2] |
| bswap | eax |
| ; | |
| ;..........<<8 >>16::48 | |
| ;..........0x00FFFFFFFFFFFF00 | |
| ; | |
| xor | edx, edx |
| mov | eax, DWORD PTR [esi+3] |
| mov | dl, BYTE PTR [esi+2] |
| mov | dh, BYTE PTR [esi+1] |
| bswap | eax |
| ; | |
| ;..........<<0 >>16::48 | |
| ;..........0xFFFFFFFFFFFF0000 | |
| ; | |
| xor | edx, edx |
| mov | eax, DWORD PTR [esi+2] |
| mov | dl, BYTE PTR [esi+1] |
| mov | dh, BYTE PTR [esi+0] |
| bswap | eax |
| ; | |
| ;..........<<8 >>8::56 | |
| ;..........0x00FFFFFFFFFFFFFF | |
| ; | |
| mov | edx, DWORD PTR [esi+0] |
| mov | eax, DWORD PTR [esi+4] |
| bswap | edx |
| bswap | eax |
| and | edx, DWORD PTR 000ffffffH |
| ; | |
| ;..........<<0 >>8::56 | |
| ;..........0xFFFFFFFFFFFFFF00 | |
| ; | |
| mov | edx, DWORD PTR [esi+4294967295] |
| mov | eax, DWORD PTR [esi+3] |
| bswap | edx |
| bswap | eax |
| and | edx, DWORD PTR 000ffffffH |
| ; | |
| ;..........<<0 >>0::64 | |
| ;..........0xFFFFFFFFFFFFFFFF | |
| ; | |
| mov | edx, DWORD PTR [esi+0] |
| mov | eax, DWORD PTR [esi+4] |
| bswap | edx |
| bswap | eax |

As a second example of a code generation routine, the routine in Table 5 below generates code that adds the value extracted from a field (contained in edx:eax) to a global variable. If the field length is <=32 bits, it generates code to skip the second add if there is no carry bit after the first add. This can be seen in the different code generated for Table 8 and Table 9. This is an advantage because one add instruction is faster than two add instructions. Especially since the first add instruction pairs with the jnc instruction and is executed in one processor clock cycle.

TABLE 5
Standard Code Generation Routine to Add
EDX:EAX to a Memory Location

```
//
//  Perform *value += edx:eax(extracted field value);
//
void Add64To64BitMemValue(U64 *sum, protocol *p, field *f)
  {// 3/2/8 or 2/3/6 insts/clocks/bytes
    OutText(“ add  DWORD PTR %09xH, eax”,
(U32)sum);
  if (f->bitlen( ) <= 32) // Value in edx:eax <= 32 bits (i.e.
edx == 0) so done if no carry
    OutText(“ jnc  NC%u”, NextLabelNumber);
    OutText(“ adc  DWORD PTR %09xH, edx”,
(U32)((char *)sum + 4));
  if (f->bitlen( ) <= 32) // Value in edx:eax <= 32 bits (i.e.
edx == 0) so done if no carry
    OutText(“NC%u:”, NextLabelNumber++);
  }
```

The class definition in Table 6 is derived from the stats class defined in U.S. Pat. No. 5,793,954, which is incorporated by reference herein. This class definition uses the code routine in Table 5 above. Only the portions required to illustrate the code generation examples are included.

TABLE 6
Class Definition Showing Collect and
Generate Collect Code Routines

```
class sum_stats: public stats
{
public:
//
// Add field value to sum of previous values
//
  void collect(U64 oldval, U64 newval)
  {
  sum += oldval;
  }
//
// Inputs:  edx:eax = extracted field value
// Outputs:  sum += extracted field value
// Registers Modified: None
//
  void sum_stats::GenerateStatsCollectCode(protocol *p, field
*f)
    {
    OutText(“”, 0, 0, p, f, “-
>sum_stats::collect(edx:eax)”); // Output protocol->field->
sum_stats::collect(edx:eax)
    Add64To64BitMemValue(&sum, p, f);
    }
//
// Data Representation
protected:
  U64 sum; // Pointer to U64 variable for summing
  U32 row; // for displays
};
```

The code in Table 7 below was used as input data, to generate the examples shown in Tables 8 and 9.

TABLE 7
Input Data for Code Generation Routines

sum_stats sum_tst(“codegen”);
protocol p(“IP_V4”, “IPFILE”);
CPa_mdiApp::CPa_mdiApp( )
{
codebuf[0] = 0;
field fff(“IHL”, 0, 24, 40, 0, 0); // define 40 bit field at
(<<0 >>24)0xFFFFFFFFFF000000
sum_tst.GenerateStatsCollectCode(&p, &fff);
field ffff(“IHL”, 0, 32, 32, 0, 0);// define 32 bit field at
(<<0 >>32)0xFFFFFFFF00000000
sum_tst.GenerateStatsCollectCode(&p, &ffff);
}

TABLE 8
Generated Code for an Extracted Field Value
of Less Than or Equal to 32 Bits

| ; | |
|---|---|
| ; (IP)->(IHL)->sum_stats::collect(edx:eax) for <= 32 bit values | |
| ; | |
| add | DWORD PTR 0008875c0H, eax |
| jnc | NC0 |
| adc | DWORD PTR 0008875c4H, edx |
| NC0: | |

TABLE 9
Generated Code for an Extracted Field
Value of Greater Than 32 Bits

| ; | |
|---|---|
| ; (IP)->(IHL)->sum_stats::collect(edx:eax) for > 32 bit values | |
| ; | |
| add | DWORD PTR 0008875c0H, eax |
| adc | DWORD PTR 0008875c4H, edx |

The following tables present the code generation routines, sample input data for the code generation routines, and resulting generated code output, used to generate code for a data filtering function. This data filtering function is a further example of the sort of functions that code can be generated for, according to an embodiment of the invention. Data filtering is one of the functions frequently performed by protocol analyzers, such as the configurable protocol analyzers discussed in the incorporated US patent references mentioned above. Those skilled in the art will appreciate that all of the functions of a protocol analyzer may be implemented in code generation routines of an embodiment of the invention. Thus, an entire protocol analyzer, specially configured to suit a particular design, may be created by applying a user-configured protocol as an input to a protocol parsing engine that has been configured with a protocol or protocols as discussed herein.

TABLE 10
Class Definitions for Code Generation Routines for Filtering Function

////////////////////////////////////////////////////////////////
////////////////
// Filter Channel NEW Criteria Class
// Consists of:

| | |
|---|---|
| // Index | - Index # of this filter channel |
| criteria | |
| // ChPtr | - Pointer back to filter channel of this |
| criteria | |
| // Ranges | - Pointer to lookup class containing |
| criteria values | |
| // Ptl | - Pointer to associated protocol class |
| // Fld | - Pointer to associated protocol field |
| class | |
| // pi | - Ptl's index in stack for |

Configuration/Display purposes only

| | |
|---|---|
| // fi | - Fld's index in protocol for |

Configuration/Display purposes only
////////////////////////////////////////////////////////////////
////////////////

| | |
|---|---|
| class newcrit | // Filter Channel Criteria |

```
Class
{
public:
//
//  Constructor
//
  newcrit(U32 Sz=MAX_FILTERS)
    : Index(0), MaxRanges(20), NumRanges(0), PtlIdx(0),
FldIdx(0),
      ChanPtr(0), PtlPtr(0), FldPtr(0), NextCrit(0)
    { /*Ranges = new verify [MaxRanges = max(2, Sz)];*/ }
//
// Overloaded Indexing Operator
//
  inline  verify * operator[] (U32 index)
  { index = min(index, MaxRanges−1); NumRanges =
max (NumRanges, index+1); return(&Ranges[index]); }
//
//  Member Functions
//
//
  void UpdateRangeAt (U32 Idx, U32 NxtIdx, U64 minval, U64
maxval, U32 OkBits, newchannel *c, protocol *p, field *f)
    {
    verify *rPtr= &Ranges[Idx];
```

| NumRanges | | = max(NumRanges, Idx+1); |
|---|---|---|
| | rPtr->prot | = (protocol *)FILTER_FRAME; |
| | rPtr->nxtidx | = NxtIdx; |
| | rPtr->minval | = minval; |
| | rPtr->maxval | = maxval; |
| | rPtr->okbits | = OkBits; |
| | rPtr->show | = TRUE; |
| | ChanPtr | = c; |
| | PtlPtr | = p; |
| | FldPtr | = f; |

// NextCrit = ?;
}
///////////////////////////////////////////////////////////////
// Data Field Access Routines
///////////////////////////////////////////////////////////////
//

| | |
|---|---|
| U32 critIndex( ) const | { return Index; } |
| void critIndex(U32 i) | { Index = i; } |
| // | |
| U32 critMaxRanges( ) const | { return MaxRanges; } |
| void critMaxRanges(U32 i) | { MaxRanges = i; } |
| // | |
| U32 critNumRanges( ) const | { return NumRanges; } |
| void critNumRanges(U32 i) | { NumRanges = i; } |
| // | |
| U32 critPtlIdx( ) const | { return PtlIdx; } |
| void critPtlIdx(U32 i) | { PtlIdx = i; } |
| // | |
| U32 critFldIdx( ) const | { return FldIdx; } |
| void critFldIdx(U32 i) | { FldIdx = i; } |
| // | |
| verify *critRanges( ) | { return &Ranges[0]; } |
| // void critRanges(verify *p) | { Ranges = p; } |
| // | |
| newchannel *critChanPtr( ) const | { return ChanPtr; } |
| void critChanPtr(newchannel *p) | { ChanPtr = p; } |
| // | |
| protocol *critPtlPtr( ) const | { return PtlPtr; } |
| void critPtlPtr(protocol *p) | { PtlPtr = p; } |
| // | |
| field *critFldPtr( ) const | { return FldPtr; } |
| void critFldPtr(field *p) | { FldPtr = p; } |
| // | |
| newcrit *critNextCrit( ) const | { return NextCrit; } |
| void critNextCrit(newcrit *p) | { NextCrit = p; } |

//
//
////////////////////////////////////////////////////////////////
///////////////
private:

| | |
|---|---|
| U32 Index; | // Zero-based index number for this |
| filter criteria | |
| U32 MaxRanges; | // Size of currently allocated array |
| U32 NumRanges; | // Number of filled-in ranges |
| U32 PtlIdx; | // protocol's index in stack for |

Configuration/Display purposes only

| | |
|---|---|
| U32 FldIdx; | // field's index in protocol for |

Configuration/Display purposes only

| | |
|---|---|
| verify Ranges[20]; | // Pointer to an Array of valid |
| ranges | |
| newchannel *ChanPtr; | // Pointer to Associated Filter |
| Class | |
| protocol *PtlPtr; | // Required for |

Configuration/Display purposes only

| | |
|---|---|
| field *FldPtr; | // Required for |

Configuration/Display purposes only

| | |
|---|---|
| newcrit *NextCrit; | // Pointer to next criteria in chain |

```
(if any)
};
//
////////////////////////////////////////////////////////////////
/////////////////////////////////
//
//
////////////////////////////////////////////////////////////////
/////////////////////////////////
//
class newchannel
{
public:
//
//  Constructors
//
  newchannel (char *fname=“”, char *cname=“”, U32
Sz=MAX_FILTERS)
    : FramesAccepted(0), FrameBitsAccepted(0), MaxCrits(20),
NumCrits(0), NextCriteriaIndex(0),
      row(0), Enable_flag(1), ChannelName(0),
FiltFileName(0)
    {
//  Criteria = new newcrit [MaxCrits = max(2, Sz)];
//
    if  (fname != (char *)NULL &&
        (FiltFileName = new char [strlen(fname)+1]) !=
(char *)NULL)
      strcpy(FiltFileName, fname);
//
    if  (cname != (char *)NULL &&
        (ChannelName = new char [strlen(cname)+1]) != (char
*) NULL)
      strcpy(ChannelName, cname);
    }
//
//  Copy constructor !!!
//
  newchannel (const newchannel& c);
//
//  Overloaded Indexing Operator
//
  inline  newcrit * operator[] (U32 index)
  { index = min(index, MaxCrits−1); NumCrits = max(NumCrits,
index+1); return(&Criteria[index]); }
  inline const newcrit * operator[] (U32 index) const {
return(&Criteria[min (index, MaxCrits−1)]); }
//
//  Member Functions
//
  inline U32 chanNumCrits( ) const { return NumCrits; }
  inline void DisableChannel( )  { NextCriteriaIndex =
NumCrits; }
  inline void Update(verify *v, U32 intf);
//
  inline U32 NciValue( )  { return(NextCriteriaIndex);
}
  inline void NciValue(U32 value) { NextCriteriaIndex = value;
}
//
  char *cname( ) const  { return ChannelName; }
  void cname (char *cname)
    {
    if  (ChannelName != (char *)NULL)
      {
      delete []ChannelName;
      ChannelName = (char *)NULL;
      }
    if  (cname != (char *)NULL &&
        (ChannelName = new char [strlen(cname)+1]) != (char
*)NULL)
      strcpy(ChannelName, cname);
    }
//
  char *fname( ) const  { return FiltFileName; }
  void fname(char *fname)
    {
    if  (FiltFileName != (char *)NULL)
      {
      delete []FiltFileName;
      FiltFileName = (char *)NULL;
      }
    if  (fname != (char *)NULL &&
        tFileName = new char [strlen(fname)+1]) !=
(char *)NULL)
      strcpy(FiltFileName, fname);
    }
//////////////////////////////////////////////
//
private:
  U64  FramesAccepted;  // Number of Frames Accepted
by this channel
  U64  FrameBitsAccepted; // Number of Bits Accepted by
this channel
  U32  MaxCrits;  // Size of currently allocated array
  U32  NumCrits;  // Number of filled-in ranges
  U32  NextCriteriaIndex; // Index of next channel
criteria to be applied
  U32  row; // for stats displays
  U32  Enable_flag; // 1=Rx, 3=Disabled
  newcrit  Criteria[20]; // Pointer to array of channel
criteria
  char  *ChannelName; // Pointer to name of channel
  char  *FiltFileName; // Filter File Name
};
//
////////////////////////////////////////////////////////////////
/////////////////////////////////
//
class NewFilters
{
public:
//
//  Constructors
//
  NewFilters(U32 Sz=MAX_FILTERS): MaxChans(20), NumChans(0),
FilterStat(PASS_FRAME)
    {
//  Chans = new newchannel[MaxChans = max(2, Sz)];
    }
//
//  Overloaded Subscript Operator
//
  inline  newchannel* operator[] (U32 index)
  { index = min(index, MaxChans-1); NumChans = max(NumChans,
index+1); return(&Chans[index]); }
  inline const newchannel* operator[] (U32 index) const {
return(&Chans[min(index, MaxChans-1)]); }
//
//  Member Functions
//
//  Number of Configured Filters
  U32 entries( ) const { return(NumChans); }
  void clear( )  { NumChans = 0; }
//
//  Chans pointer
  newchannel *ChansPtr(void) { return(Chans); }
//
//
  U32 FrameFilterStatus( ) const { return(FilterStat); }
  void FrameFilterStatus(U32 Status) { FilterStat = Status; }
//
//  Generate code for this filter channel
  void GenerateFilterCode(void);
//
////////////////////////////////////////////////////////////////
///////////////
private:
  U32   MaxChans; // Size of currently allocated array
  U32   NumChans; // Number of filled-in ranges
  U32   FilterStat;
  newchannel Chans[20]; // Pointer to Configured Filters
Table
};
```

TABLE 11
Code Generation Routines for Filtering Function

```
void protocol::GenerateFilterHeaderLenCode( )
{
U32 HeaderLen=0;
OutText(“ ; Add Number of any optional bytes in after processing
%s”, (U32)protocol_name);
switch(hlfield->protlen( ))
{ //  Compute Header Length Here
  case 3: HeaderLen += hlfield->bitlen( );
  case 2: HeaderLen += (hlfield->offset( ) * BITS_PER_BYTE);
  case 1: switch(hlfield->hdlen( )/BITS_PER_BYTE)
        {
        case 0: break;
        case 1:
        case 2:
        case 4:
        case 8: OutText(“  lea  ecx, DWORD
PTR [ecx+eax*%u−%u]”, hlfield->hdlen( )/8, num_bits/8 -
HeaderLen);
            break;
        default:OutText(“  mov  edx, OFFSET
FLAT %u”, hlfield->hdlen( )/8, num_bits/8);
            OutText(“  imul  eax, edx”);
            if  ((HeaderLen-num_bits/8) != 0)
              OutText(“  add  eax,
%u”, HeaderLen-num_bits/8);
            break;
        }
      break;
  default:OutText(“; ERROR!!!!: (%s)->GenerateHeaderLenCode( ):
->protlen( ) is %u”, (U32)protocol_name, hlfield->protlen( ));
      return; // This is an illegal case
  }
}
//
//
//
static void OutputCompare(char *p, char *f, char *op, U32 Idx, U32 RngIdx, U32 Sz, U64
MinV)
{
char *reg, *xH, *ldr, sptr[256];
U64 V;
switch(Sz)
  {
  case 1: reg = “al”; xH =“ BYTE PTR %03xH  ”; V =
(U8)MinV; break;
  case 2: reg = “eax”; xH = “DWORD PTR %05xH  ” ; V =
bswap((U16)MinV); break;
  case 3: reg = “eax”; xH = “DWORD PTR %09xH” ; V =
wswap((U32)MinV); break;
  case 4: reg = “eax”; xH = “DWORD PTR %09xH” ; V =
wswap((U32)MinV); break;
  case 5:
  case 6:
  case 7:
  case 8: break;
  }
if  (Idx == 0)
  {
  if  (RngIdx == 0)
    ldr = “if  (”;
  }
else
  ldr = “  ”;
//
sprintf(sptr, “  cmp  %s, %s ;  %s%s->%s
== 0x%X%s”,
    reg, xH, ldr, p, f, (U32)MinV, op);
OutText(sptr, (U32)V);
}
//
//
//
static void OutputCompareMinV(char *p, char *f, char *op, U32 Idx, U32 RngIdx, U32 Sz, U64
MinV)
{
char *reg, *xH, *ldr, sptr[256];
switch(Sz)
  {
  case 1: reg = “al”; xH =“ BYTE PTR %03xH  ”;
(U8)MinV; break;
  case 2: reg = “eax”; xH = “DWORD PTR %05xH  ”  ;
(U16)MinV; break;
  case 3: reg = “eax”; xH = “DWORD PTR %09xH”  ;
(U32)MinV; break;
  case 4: reg = “eax”; xH = “DWORD PTR %09xH”  ;
(U32)MinV; break;
  case 5:
  case 6:
  case 7:
  case 8: break;
  }
ldr = “ (”;
if  (Idx == 0)
  {
  if  (RngIdx == 0)
    ldr = “if  ((”;
  }
sprintf(sptr, “  cmp  %s, %s  ; %s%s->%s
>= 0x%X%s”,
    reg, xH, ldr, p, f, (U32)MinV, op);
OutText(sptr, (U32)MinV);
}
//
//
//
static void OutputCompareMaxV(char *p, char *f, char *op, U32 Idx, U32 Sz, U64 MaxV)
{
char *reg, *xH, *ldr, sptr[256];
switch(Sz)
  {
  case 1: reg = “al”;  xH =“ BYTE PTR %03xH  ”;
(U8)MaxV; break;
  case 2: reg = “eax”; xH = “DWORD PTR %05xH  ” ;
(U16)MaxV; break;
  case 3: reg = “eax”; xH = “DWORD PTR %09xH” ;  (U32)MaxV;
break;
  case 4: reg = “eax”; xH = “DWORD PTR %09xH” ;  (U32)MaxV;
break;
  case 5:
  case 6:
  case 7:
  case 8: break;
  }
  ldr = “)”;
sprintf(sptr,  “ cmp  %s, %s  ; %s%s->%s
<= 0x%X%s%s”,
    reg, xH, “ ”, p, f, (U32)MaxV, ldr, op);
OutText(sptr, (U32)MaxV);
}
//
// Generates code (Routine) that implements all configured
filters on an interface
//  The generated code expects the following inputs:
//  esi - ParsePtr
    // The generated code produces the following outputs:
//  eax - updated frame filter status
//
//
// THE FOLLOWING CODE ASSUMES FILTER CRITERIA ARE IN
MONOTONICALLY INCREASING OFFSET ORDER (i.e. sorted by
protocol, field)
//
void NewFilters::GenerateFilterCode(void)
{
char *ldr;
OutText(“;”);
OutText(“; Generated Filtering Code”);
OutText(“;”);
OutText(“  xor  edx, edx
; Bits correspond to Filter/Receive Channels”);
for (U32 ChannelIdx=0; ChannelIdx<NewFilts->entries( );
ChannelIdx++)
  { // For each filter channel
  U32  OptionalOffset = 0;
  U32  FixedOffset = 0;
  U64  ValueMask = 0xffffffffffffffff;
  newchannel *CurrChannel = NewFilts->operator[] (ChannelIdx);
  protocol *OldProt, *CurrProt;
  OutText(“;;;;;;;;;;;;;;;;;;; FilterChannel%u
;;;;;;;;;;;;;;;;;”, ChannelIdx);
  OldProt = CurrChannel->operator[] (0) ->critPtlPtr( );
  for (U32 CriteriaIdx=0; CriteriaIdx<CurrChannel-
>chanNumCrits( ); CriteriaIdx++)
    { // For each criteria in each filter channel
    U32  RangeIdx;
    newcrit  *CurrCriteria = CurrChannel-
>operator[] (CriteriaIdx);
    field  *CurrField = CurrCriteria->critFldPtr( );
    CurrProt = CurrCriteria->critPtlPtr( );
//
//  Add standard protocol header length to FixedOffset if
this is the last field in the current protocol
//
    if  (CurrProt != OldProt)
      FixedOffset += (OldProt->numbits( )/8);
//
//  Create Indexed Label for Each Criteria Processed
//
    OutText(“Chan%uCrit%u:”, ChannelIdx, CriteriaIdx);
    for (RangeIdx=0; RangeIdx<CurrCriteria->critNumRanges( );
RangeIdx++)
      { // For each range in each criteria in each filter
channel
      verify *CurrRange = CurrCriteria-
>operator[] (RangeIdx);
      U64 minvalue=CurrRange->minval, maxvalue=CurrRange-
>maxval;
//
//  Is criteria value a range or single value?
//
        U32 HasRanges = (minvalue != maxvalue);
//
//  Generate Range Comparison Code
//
        U32 Size = CurrField-
>GenerateFilterExtractionCode(HasRanges, ValueMask, FixedOffset,
OptionalOffset);
      OutText(“Chan%uCrit%uRange%u:”, ChannelIdx,
CriteriaIdx, (protocol *)RangeIdx);
      if  (HasRanges == FALSE)
        { // Single value comparison
        if  ((U32) CurrRange->prot == FILTER_FRAME)
          {
          if  (CurrRange->nxtidx != (CriteriaIdx+1))
            { // This an “OR” condition ... and the
filter is a match
            if  (((RangeIdx+1) == CurrCriteria-
>critNumRanges( )) &&((CriteriaIdx+1) == CurrChannel-
>chanNumCrits( )))
              ldr = “)”;
            else
              ldr = “ ||”;
            OutputCompare(CurrProt->pname( ),
CurrField->name( ), ldr, CriteriaIdx, RangeIdx, Size, minvalue);
              if  (CurrRange->nxtidx == CurrChannel-
>chanNumCrits( )) // Filter Channel Satisfied here
              OutText(“  je
Chan%uMatch”, ChannelIdx);
            else
              OutText(“ je
Chan%uCrit%uRange%u”, ChannelIdx, CurrRange->nxtidx);
            }
          else
            { // This is an “AND” condition
            if  (((RangeIdx+1) == CurrCriteria-
>critNumRanges( )) &&((CriteriaIdx+1) == CurrChannel-
>chanNumCrits( )))
              ldr = “ )”;
            else
              ldr = “ &&”;
            if  ((RangeIdx+1) == CurrCriteria-
>critNumRanges( )) // Last Range in Criteria ?
              {
              OutputCompare(CurrProt->pname( ),
CurrField->name( ), ldr, CriteriaIdx, RangeIdx, Size, minvalue);
              OutText(“  jne
Chan%uNoMatch”, ChannelIdx);
              }
            else
              {
              OutputCompare(CurrProt->pname( ),
CurrField->name( ), ldr, CriteriaIdx, RangeIdx, Size, minvalue);
              OutText(“  je
Chan%uCrit%uRange%u”, ChannelIdx, CriteriaIdx, (protocol
*) (RangeIdx+1));
              }
            }
          }
        else // PASS_FRAME
          {
          if  (CurrRange->nxtidx != (CriteriaIdx+1))
            { // This an “OR” condition ... and the
filter is a match
            OutputCompare(CurrProt->pname( ),
CurrField->name( ), “ &&”, CriteriaIdx, RangeIdx, Size,
minvalue);
            OutText(“  je
Chan%uMatch”, ChannelIdx);
            }
          else
            { // This is an “AND” condition ...
            OutputCompare(CurrProt->pname( ),
CurrField->name( ), “ &&”, CriteriaIdx, RangeIdx, Size,
minvalue);
            OutText(“  jne
Chan%uFilter”, ChannelIdx+1);
            }
          }
        } // Single value comparison
      else
        { // Range of Values
        if  ((U32)CurrRange->prot == FILTER_FRAME)
          { // FILTER_FRAME
          if  (CurrRange->nxtidx != (CriteriaIdx+1))
            { // This an “OR” condition ... and the
filter is a match
            if  (((RangeIdx+1) == CurrCriteria-
>critNumRanges( )) &&((CriteriaIdx+1) == CurrChannel-
>chanNumCrits( )))
              ldr = “)”;
            else
              ldr = “ ||”;
            OutputCompareMinV(CurrProt->pname( ),
CurrField->name( ), “ &&”, CriteriaIdx, RangeIdx, Size,
minvalue);
            OutText(“  jb
Chan%uCrit%uRange%u”, ChannelIdx, CriteriaIdx, (protocol
*) (RangeIdx+1));
            OutputCompareMaxV(CurrProt->pname( ),
CurrField->name( ), “ ||”, CriteriaIdx, Size, maxvalue);
            OutText(“  jbe
Chan%uMatch”, ChannelIdx);
            }
          else
            { // This is an “AND” condition ...
            if  (((RangeIdx+1) == CurrCriteria-
>critNumRanges( )) &&((CriteriaIdx+1) == CurrChannel-
>chanNumCrits( )))
              ldr = “)”;
            else
              ldr = “ &&”;
            OutputCompareMinV(CurrProt->pname( ),
CurrField->name( ), “ &&”, CriteriaIdx, RangeIdx, Size,
minvalue);
            OutText(“  jb
Chan%uNoMatch”, ChannelIdx);
            OutputCompareMaxV(CurrProt->pname( ),
CurrField->name( ), “ &&”, CriteriaIdx, Size, maxvalue);
            OutText(“  ja
Chan%uNoMatch”, ChannelIdx);
            }
          } // FILTER_FRAME
        else
          { // PASS_FRAME
          if  (CurrRange->nxtidx != (CriteriaIdx+1))
            { // This an “OR” condition ... and the
filter is a match
            OutputCompareMinV(CurrProt->pname( ),
CurrField->name( ), “ &&”, CriteriaIdx, RangeIdx, Size,
minvalue);
            OutText(“  jb
Chan%uNoMatch”, ChannelIdx);
            }
          else
            { // This is an “AND” condition ...
            OutputCompareMinV(CurrProt->pname( ),
CurrField->name( ), “ &&”, CriteriaIdx, RangeIdx, Size,
minvalue);
            OutText(“  jb
Chan%uCrit%uRange%u”, ChannelIdx, CriteriaIdx, (protocol
*) (RangeIdx+1));
            }
          if  (CurrRange->nxtidx != (CriteriaIdx+1))
            {
            OutputCompareMaxV(CurrProt->pname( ),
CurrField->name( ), “ ||”, CriteriaIdx, Size, maxvalue);
            OutText(   “jbe
Chan%uMatch”, ChannelIdx);
            }
          else
            {
            OutputCompareMaxV(CurrProt->pname( ),
CurrField->name( ), “ ||”, CriteriaIdx, Size, maxvalue);
            OutText(   “ja  Filter%u”,
ChannelIdx+1);
            }
          } // PASS_FRAME
        } // Range of Values
      } // For each range in each criteria in each filter
channel
//
//  Look for every protocol with a Header Length field that
may indicate optional bytes
//
    if  (CurrProt->HlField( ))
      {
      if  (CriteriaIdx<(CurrChannel->chanNumCrits( )−1))
        {
        OutText(“ ; Extract Header Length Field in %s”,
(U32) CurrProt->pname( ));
        CurrProt->HlField( )-
>GenerateFilterExtractionCode(CurrProt, FALSE);
        CurrProt->GenerateFilterHeaderLenCode( );
        }
      OptionalOffset = TRUE;
      }
//
//  Save previous protocol so can add fixed header length to
filtering process
//
    OldProt = CurrProt;
    } // For each criteria in each filter channel
//
//  Generate Channel Index Return Value
//
  OutText(“Chan%uMatch:”, ChannelIdx);
  OutText(“  or  edx, %09xH
; Index of Channel/Filter Number”, 1<<ChannelIdx);  // Frame
Status that doesn't match this filter
//  if  (USER WANTS 1st MATCH)
//  OutText(“// jmp FilteringDone”);
  OutText(“Chan%uNoMatch:”, ChannelIdx);
//
  } // For each filter channel
//
OutText(“  mov  eax, edx
; Bits correspond to Filter/Receive Channels”);
}
```

The code in Table 12 below was used as input data to generate the example executable code in Table 14 below:

TABLE 12
Input Data for Code Generation Routines for Filtering Function

NewFilters NewFilter, *NewFilts = &NewFilter;

| | |
|---|---|
| p.protname(“ETHERII”); | e = ListPtr->find(&p)->prot( ); |
| p.protname(“IP_V4”); | i = ListPtr->find(&p)->prot( ); |
| p.protname(“TCP”); | t = ListPtr->find(&p)->prot( ); |
| p.protname(“LLC1”); | l1 = ListPtr->find(&p)->prot( ); |
| p.protname(“LLC2”); | l2 = ListPtr->find(&p)->prot( ); |
| p.protname(“pether”); | m = ListPtr->find(&p)->prot( ); |

newchannel *Chnl0 = NewFilts->operator[](0), *Chnl1 = NewFilts-
>operator[](1), *Chnl2 = NewFilts->operator[](2);
//if (e->typ == 0x0800 && IP->Port == 0x06 && TCP->SrcPort ==
0x0017)
Chnl0->operator[](0)->UpdateRangeAt(0, 1, 0x00000800,
0x00000800, ALLNUMBERS, Chnl0, e, e->operator[](2));
Chnl0->operator[](1)->UpdateRangeAt(0, 2, 0x00000006,
0x00000006, ALLNUMBERS, Chnl0, i, i->operator[](8));
Chnl0->operator[](2)->UpdateRangeAt(0, 3, 0x00000017,
0x00000017, ALLNUMBERS, Chnl0, t, t->operator[](0));
//if (e->typ == 0x0800 || ((e->typ >=0x002e && e->typ <=
0x05dc) && ((l1->L1 >= 0x06060300 && l1->L1 <= 0x060603ff) ||
((l1->L1 == 0xAAAA0300) && (l2->L1 == 0x00000800)))))
Chnl1->operator[](0)->UpdateRangeAt(0, 3, 0x00000800,
0x00000800, ALLNUMBERS, Chnl1, e, e->operator[](2));
Chnl1->operator[](0)->UpdateRangeAt(1, 1, 0x0000002e,
0x000005dc, ALLNUMBERS, Chnl1, e, e->operator[](2));
Chnl1->operator[](1)->UpdateRangeAt(0, 3, 0x06060300,
0x060603ff, ALLNUMBERS, Chnl1, l1, l1->operator[](0));
Chnl1->operator[](1)->UpdateRangeAt(1, 2, 0xaaaa0300,
0xaaaa0300, ALLNUMBERS, Chnl1, l1, l1->operator[](0));
Chnl1->operator[](2)->UpdateRangeAt(0, 3, 0x00000800,
0x00000800, ALLNUMBERS, Chnl1, l2, l2->operator[](0));
//if ((e->daddr[2] == 0x1122 || e->saddr[2] == 0x0049) && e-
>typ == 0x0800)
Chnl2->operator[](0)->UpdateRangeAt(0, 2, 0x00001122,
0x00001122, ALLNUMBERS, Chnl2, m, m->operator[](2));
Chnl2->operator[](1)->UpdateRangeAt(0, 2, 0x00000049,
0x00000049, ALLNUMBERS, Chnl2, m, m->operator[](5));
Chnl2->operator[](2)->UpdateRangeAt(0, 3, 0x00000800,
0x00000800, ALLNUMBERS, Chnl2, m, m->operator[](6));

The code of Table 12 above translates to the more readable table of filter channels, criteria, and ranges for each example, in Table 13 below.

TABLE 13
Input Data for Code Generation Routines for Filtering Function, Table Form

| | | | Nxt | | | Even/ | Curr | |
|---|---|---|---|---|---|---|---|---|
| | Criteria | Range | Criteria | Min | Max | Odd/All | Protocol | Curr Field |
| Channel Idx | Idx | Idx | Idx | Value | Value | Bits | Ptr | Ptr |
| // Example 1 | | | | | | | | |
| (Channel 0) | | | | | | | | |
| 0 | 0 | 0 | 1 | 0x800 | 0x800 | All | ETHERII | type |
| 0 | 1 | 0 | 2 | 0x6 | 0x6 | All | IP_V4 | Protocol |
| 0 | 2 | 0 | 3 | 0x17 | 0x17 | All | TCP | SourcePort |
| // Example 2 | | | | | | | | |
| (Channel 1) | | | | | | | | |
| 1 | 0 | 3 | 0 | 0x800 | 0x800 | All | ETHERII | type |
| 1 | 0 | 1 | 1 | 0x2e | 0x5dc | All | ETHERII | type |
| 1 | 1 | 0 | 3 | 0x06060300 | 0x060603ff | All | LLC1 | LLC1 |
| 1 | 1 | 1 | 2 | 0xaaaa0300 | 0xaaaa0300 | All | LLC1 | LLC1 |
| 1 | 2 | 0 | 3 | 0x800 | 0x800 | All | LLC2 | LLC2 |
| // Example 3 | | | | | | | | |
| (channel 2) | | | | | | | | |
| 2 | 0 | 0 | 2 | 0x1122 | 0x1122 | All | pether | Dadr2 |
| 2 | 1 | 0 | 2 | 0x49 | 0x49 | All | pether | Sadr2 |
| 2 | 2 | 0 | 3 | 0x800 | 0x800 | All | pether | TypeLen |

In this example, one of the advantages of using the protocol description to generate filtering code is apparent. The length of the IP_V4 protocol header is variable (20 bytes are always there and up to 40 bytes of options may be added in 4 byte increments). This means that there are 11 possible header sizes (20, 24, 28, . . . 60). The generated code automatically accounts for this possibility by extracting the actual header length from the header contained in the input data, and adding it to all subsequent filtering checks. To do this filtering the more traditional way with content addressable memory (CAM) would require the user to enter all eleven possibilities into the CAMs. The code generation routines discussed above can be altered to issue commands to automatically program the CAMs with the required values and masks after the filter has been configured by specifying protocols, fields, and (un)acceptable ranges (criteria) of values. This is intuitively more obvious and easier for a typical user to use. The code generated by applying the input data of Tables 12 and 13 to the code generation routines of Table 11 are shown below in Tables 14-16.

TABLE 14
Generated Code for Filtering Function, Example 1

| ; | |
|---|---|
| ; Generated Filtering Code | |
| ; | |
| xor edx, edx | ; Bits |
| correspond to Filter/Receive Channels | |
| ;;;;;;;;;;;;;;;;;;; FilterChannel0 ;;;;;;;;;;;;;;;;; | |
| ; | |
| ; if (ETHERII->type == 0x800 && | |
| ; IP_V4->Protocol == 0x6 && | |
| ; TCP->SourcePort == 0x17) | |
| Chan0Crit0: | |
| xor eax, eax | |
| mov ax, WORD PTR [esi+12] | |
| Chan0Crit0Range0: | |
| cmp eax, DWORD PTR 00008H | ; if |
| (ETHERII->type == 0x800 && | |
| jne Chan0NoMatch | |
| Chan0Crit1: | |
| xor eax, eax | |
| mov al, BYTE PTR [esi+23] | |
| Chan0Crit1Range0: | |
| cmp al, BYTE PTR 006H | ; |
| IP_V4->Protocol == 0x6 && | |
| jne Chan0NoMatch | |
| ; Extract Header Length Field in IP_V4 | |
| ; | |
| ; ..........<<4 >>60::4 | |
| ; ..........0x0F00000000000000 | |
| ; | |
| ; Extract IP_V4 Header Length Field | |
| xor eax, eax | |
| mov al, BYTE PTR [esi+0] | |
| and al, BYTE PTR 0fH | |
| ; Account for any optional bytes in IP_V4 header after processing | |
| IP_V4 | |
| lea ecx, DWORD PTR [ecx+eax*4−20] | |
| Chan0Crit2: | |
| xor eax, eax | |
| mov ax, WORD PTR [esi+ecx+34] | |
| Chan0Crit2Range0: | |
| cmp eax, DWORD PTR 01700H | ; |
| TCP->Source Port == 0x17) | |
| jne Chan0NoMatch | |
| Chan0Match: | |
| or edx, 000000001H | ; Index |
| of Channel/Filter Number | |
| Chan0NoMatch: | |

TABLE 15
Generated Code for Filtering Function, Example 2

```
;
;if  (ETHERII->type == 0x800 ||
; (ETHERII->type >= 0x2e && ETHERII->type <= 0x5dc &&
;  ((LLC1->LLC1 >= 0x06060300 && LLC1->LLC1 <=
      0x060603ff)
||
;  (LLC1->LLC1 == 0xaaaa0300 && LLC2->LLC2 == 0x800))))
;
;;;;;;;;;;;;;;;;;;; FilterChannel1 ;;;;;;;;;;;;;;;;;
Chan1Crit0:
        xor  eax, eax
        mov  ax, WORD PTR [esi+12]
Chan1Crit0Range0:
```

| | |
|---|---|
| cmp eax, DWORD PTR 00008H | ; if |
| (ETHERII->type == 0x800 \|\| | |
| je Chan1Match | |
| xor eax, eax | |
| mov ah, BYTE PTR [esi+12] | |
| mov al, BYTE PTR [esi+13] | |
| Chan1Crit0Range1: | |
| cmp eax, DWORD PTR 0002eH | ; |
| (ETHERII->type >= 0x2E && | |
| jb Chan1NoMatch | |
| cmp eax, DWORD PTR 005dcH | ; |
| ETHERII->type <= 0x5DC) && | |
| ja Chan1NoMatch | |
| Chan1Crit1: | |
| mov eax, DWORD PTR [esi+14] | |
| bswap eax | |
| Chan1Crit1Range0: | |
| cmp eax, DWORD PTR 006060300H | ; |
| (Llc1->LLC1 >= 0x6060300 && | |
| jb Chan1Crit1Range1 | |
| cmp eax, DWORD PTR 0060603ffH | ; |
| Llc1->LLC1 <= 0x60603FF) \|\| | |
| jbe Chan1Match | |
| mov eax, DWORD PTR [esi+18] | |
| Chan1Crit1Range1: | |
| cmp eax, DWORD PTR 00003aaaaH | ; |
| Llc1->LLC1 == 0xAAAA0300 && | |
| jne Chan1NoMatch | |
| Chan1Crit2: | |
| mov eax, DWORD PTR [esi+22] | |
| Chan1Crit2Range0: | |
| cmp eax, DWORD PTR 000080000H | ; |
| Llc2->LLC2 == 0x800) | |
| jne Chan1NoMatch | |
| Chan1Match: | |
| or edx, 000000002H | ; Index |
| of Channel/Filter Number | |
| Chan1NoMatch: | |

TABLE 16
Generated Code for Filtering Function, Example 3

| ; | |
|---|---|
| ; if ((pether->Dadr2 == 0x1122 \|\| | |
| ; pether->Sadr2 == 0x49) && | |
| ; pether->TypeLen == 0x800) | |
| ; | |
| ; | |
| ;;;;;;;;;;;;;;;;;;; FilterChannel2 ;;;;;;;;;;;;;;;;; | |
| Chan2Crit0: | |
| xor eax, eax | |
| mov ax, WORD PTR [esi+4] | |
| Chan2Crit0Range0: | |
| cmp eax, DWORD PTR 02211H | ; if |
| (pether->Dadr2 == 0x1122 \|\| | |
| je Chan2Crit2Range0 | |
| Chan2Crit1: | |
| xor eax, eax | |
| mov ax, WORD PTR [esi+10] | |
| Chan2Crit1Range0: | |
| cmp eax, DWORD PTR 04900H | ; |
| pether->Sadr2 == 0x49 && | |
| jne Chan2NoMatch | |
| Chan2Crit2: | |
| xor eax, eax | |
| mov ax, WORD PTR [esi+12] | |
| Chan2Crit2Range0: | |
| cmp eax, DWORD PTR 00008H | ; |
| pether->TypeLen == 0x800) | |
| jne Chan2NoMatch | |
| Chan2Match: | |
| or edx, 000000004H | ; Index |
| of Channel/Filter Number | |
| Chan2NoMatch: | |
| mov eax, edx | ; Bits |
| correspond to Filter/Receive Channels | |

By adding routines to generate code for every function performed by the protocol description, it would possible to generate code that could first filter network frames, then parse frames containing any pre-configured protocols and fields while also generating code for gathering statistics, verifying checksums and CRCs, varying field values/recomputing checksums and CRCs, and performing routing (route table lookups). Also, by adding additional code generation support routines it would be possible to create a system/application that could generate code that implements an entire protocol or even an entire switch and/or router, all from user configured protocols, fields, filters, lookups, varies, checksums, CRCs, statistics, and route tables.

Typically, switches/routers have two paths through the hardware/software. A “fast path” for operations that are performed often, and a slower “normal path” for operations that are performed infrequently and are not time critical. Using the principles discussed above, a system/application that could generate code to implement the “fast path” code can be produced. This would allow the switch/router owner to configure/tailor (reprogram) the “fast path” protocols and features supported, in the field.

In the foregoing specification, the invention has been described with reference to specific embodiments thereof. It will, however, be evident that various modifications and changes may be made thereto without departing from the broader spirit and scope of the invention. For example, the content protection system could be used to protect content other than digital content, such as analog content; or the code generation routines could be used to generate other types of code, such as source code, machine language, or even English or other human-readable language code or documentation. The specification and drawings are, accordingly, to be regarded in an illustrative rather than restrictive sense, and the invention is not to be restricted or limited except in accordance with the following claims and their legal equivalents.

We claim:

1. A method of securely distributing digital content, comprising:
receiving a content distribution request from a content user;
retrieving a digital content item in response to the content distribution request;
generating a first encryption algorithm for encrypting the digital content item;
configuring a protocol parsing engine to encrypt the digital content item, using the first encryption algorithm;
encrypting the digital content item using the configured protocol parsing engine; and
transmitting the encrypted digital content item to the content user.

2. The method of claim 1, further comprising generating a first encryption key.

3. The method of claim 2, wherein the configuring step further comprises using the first encryption key.

4. The method of claim 1, further comprising recording an encryption identifier adapted to identify the first encryption algorithm.

5. The method of claim 1, wherein the first encryption algorithm is different from a second encryption algorithm, the second encryption algorithm being a previously generated encryption algorithm used to encrypt a second digital content item transmitted to a second content user.

6. The method of claim 1, wherein generating the encryption algorithm comprises retrieving the encryption algorithm from a pool of encryption algorithms.

7. A method of securely accessing encrypted digital content, comprising:
requesting from a content provider access to encrypted digital content;
receiving decryption information from the content provider;
decrypting the encrypted digital content using the decryption information;
accessing the decrypted digital content; and
deleting the decryption information.

8. The method of claim 7, wherein the encrypted digital content is stored locally.

9. The method of claim 7, wherein the decryption information comprises an executable decryption code module.

10. The method of claim 9, wherein the executable decryption code module is created on demand by the content provider.

11. The method of claim 10, wherein the executable decryption code module is created by a protocol description configured to generate executable code.

12. The method of claim 7, wherein the received decryption information is stored in volatile memory.

13. The method of claim 7, wherein the decrypted digital content is stored in volatile memory.

14. The method of claim 7, further comprising deleting the decrypted digital content once it has been accessed.

15. The method of claim 7, further comprising receiving encryption information from the content provider and re-encrypting the decrypted digital content, using the encryption information.

16. The method of claim 15, wherein the encryption information is different from second encryption information used to initially encrypt the decrypted digital content.

17. A method of providing secure access to encrypted digital content, comprising:
receiving a request to access encrypted digital content;
retrieving a decryption algorithm for decrypting the encrypted digital content;
configuring a protocol description to generate a code module for decrypting the encrypted digital content, using the decryption algorithm;
generating the code module for decrypting the encrypted digital content, using the configured protocol description;
transmitting the code module to the content user.

18. The method of claim 17, wherein the code module comprises an executable code module.

19. The method of claim 17, wherein the request to access encrypted digital content comprises an identifier identifying the digital content.

20. The method of claim 19, wherein retrieving the decryption algorithm comprises regenerating a decryption algorithm, based on the identifier.
